(19) United States
(12) Patent Application Publication
(10) Pub. No.: US 2026/0178129 A1
(43) Pub. Date: Jun. 25, 2026

(54) METHOD OF CONTROLLING ELECTRONIC DEVICE BY USING WEARABLE DEVICE, AND WEARABLE DEVICE PERFORMING THE METHOD

(71) Applicant: SAMSUNG ELECTRONICS CO., LTD., Suwon-si (KR)

(72) Inventors: Dongwook KIM, Suwon-si (KR); Minsup Kim, Suwon-si (KR); Jungseop kim, Suwon-si (KR); Sooho Park, Suwon-si (KR); Woosung Chung, Suwon-si (KR)

(73) Assignee: SAMSUNG ELECTRONICS CO., LTD., Suwon-si (KR)

(21) Appl. No.: 19/465,827

(22) Filed: Jan. 30, 2026

Related U.S. Application Data
(63) Continuation of application No. PCT/KR2025/021280, filed on Dec. 10, 2025.

(30) Foreign Application Priority Data
Dec. 20, 2024 (KR) 10-2024-0193329
Mar. 13, 2025 (KR) 10-2025-0032937

(51) Int. Cl. G06F 3/01; G06F 3/0346; G06F 3/0485; H04N 21/422; H04N 21/45; H04N 21/472

(52) U.S. Cl. CPC G06F 3/017; G06F 3/011; G06F 3/0346; G06F 3/0485; H04N 21/42208; H04N 21/4532; H04N 21/47217

(57) ABSTRACT

An operating method of a wearable device includes activating a remote control of an electronic device based on a trigger gesture being identified by using at least one sensor comprised in the wearable device that detects a first motion of the wearable device; determining, in response to a second motion of the wearable device and a direction in which the wearable device faces, an operation to be performed by the electronic device; and based on identifying the second motion of the wearable device, transmitting, to the electronic device, a command that causes the electronic device to perform the operation of the electronic device, the operation corresponding to the second motion of the wearable device.

### CROSS-REFERENCE TO RELATED APPLICATIONS

This application is a Continuation Application of International Application PCT/KR2025/021280 filed on Dec. 10, 2025, which claims benefit of Korean Provisional Application No. 10-2024-0193329, filed on Dec. 20, 2024, and Korean Patent Application No. 10-2025-0032937, filed on Mar. 13, 2025, at the Korean Intellectual Property Office, the disclosures of which are incorporated herein in their entireties by reference.

### TECHNICAL FIELD

The disclosure relates to a method of controlling an electronic device by using a wearable device, and a wearable device performing the method, and more particularly, to a wearable device for controlling an electronic device, based on a motion of the wearable device, and an operating method of the wearable device.

### BACKGROUND ART

Various types of wearable devices including smart watches, smart rings, smart bands, smart clothing, and head-mounted displays, may be provided to a user. A wearable device may control other electronic devices based on an input obtained by the wearable device.

The wearable device may start control of other electronic devices by executing a particular application. When the wearable device controls an electronic device based on a touch input from a user, the user has to alternate their gaze between the electronic device and the wearable device to operate the wearable device, which is inconvenient for the user, and even dangerous if the user is operating a vehicle while using the wearable device to control the electronic device.

### DISCLOSURE

### Technical Solution

According to an aspect of the disclosure, an operating method of a wearable device, the operating method including: activating a remote control of an electronic device based on a trigger gesture being identified by using at least one sensor included in the wearable device that detects a first motion of the wearable device; determining, in response to a second motion of the wearable device and a direction in which the wearable device faces, an operation to be performed by the electronic device; and based on identifying the second motion of the wearable device, transmitting, to the electronic device, a command that causes the electronic device to perform the operation of the electronic device, the operation corresponding to the second motion of the wearable device.

According to an aspect of the disclosure, a wearable device including: a communication interface; memory including at least one instruction; at least one processor including processing circuitry operatively coupled to the memory; a display; and a plurality of sensors including an acceleration sensor and a gyroscope sensor, in which the at least one instruction, when executed by the at least one processor, causes the wearable device to: activate a remote control of an electronic device based on a trigger gesture being identified by using at least one sensor included in the wearable device that detects a first motion of the wearable device, determine, in response to a second motion of the wearable device and a direction in which the wearable device faces, an operation to be performed by the electronic device, and based on identifying the second motion of the wearable device, transmit, to the electronic device, a command that causes the electronic device to perform the operation of the electronic device, the operation corresponding to the second motion of the wearable device.

According to an aspect of the disclosure, an electronic device including: a communication interface; a memory including at least one instruction; at least one processor including processing circuitry operatively coupled to the memory; and a display, in which the at least one instruction, when executed by the at least one processor, causes the electronic device to: obtain a preference of a user for at least one of a plurality of content genres or a plurality of streaming services, obtain a usage history of the user of the electronic device for a defined period, obtain one or more focus priority orders for a plurality of pieces of content output on the display of the electronic device based on at least one of the preference or the usage history, and based on determining there are two or more pieces of content that correspond to a highest focus priority order, determine a focus of the electronic device, based on a direction in which a wearable device is moved.

According to an embodiment of the disclosure, provided is a computer-readable recording medium having recorded thereon a program for performing, on a computer, any one of the operating methods described above or below.

### DESCRIPTION OF DRAWINGS

The disclosure will become apparent and more readily appreciated from the following description, taken in conjunction with the accompanying drawings wherein like reference numerals denote like structural elements.

FIG. 1 is a conceptual diagram of a method by which a wearable device and an electronic device operate, according to one or more embodiments of the disclosure.

FIG. 2 is a block diagram illustrating configurations of a wearable device and an electronic device according to an embodiment of the disclosure.

FIG. 3 is a flowchart for describing operations of a wearable device according to an embodiment of the disclosure.

FIG. 4A is a reference diagram for describing an operation in which a wearable device starts remote control of an electronic device, according to an embodiment of the disclosure.

FIG. 4B is a reference diagram for describing an operation in which a wearable device starts remote control of an electronic device, according to an embodiment of the disclosure.

FIG. 5A is a reference diagram for describing a process of selecting an operation to be performed in an electronic device according to a motion of a wrist of a user wearing a wearable device according to a direction in which the wearable device faces, according to an embodiment of the disclosure.

FIG. 5B is a reference diagram for describing a process of selecting a gesture mapping table in which functions of an electronic device are mapped to gestures of a user wearing a wearable device, according to a direction in which the wearable device faces, according to an embodiment of the disclosure.

FIG. 6A is a reference diagram for describing a first gesture mapping table according to an embodiment of the disclosure.

FIG. 6B is a reference diagram for describing a second gesture mapping table according to an embodiment of the disclosure.

FIG. 6C is a reference diagram for describing a user guide that corresponds to a gesture mapping table output on a wearable device, according to an embodiment of the disclosure.

FIG. 6D is a reference diagram for describing a user guide that corresponds to a gesture mapping table output on a wearable device, according to an embodiment of the disclosure.

FIG. 7 is a reference diagram for describing a user interface that corresponds to each gesture mapping, according to an embodiment of the disclosure.

FIG. 8 is a reference diagram for describing a method by which an artificial intelligence (AI) model recognizes a gesture, according to an embodiment of the disclosure.

FIG. 9 is a reference diagram for describing a method by which an AI model is trained with respect to gestures, according to an embodiment of the disclosure.

FIG. 10 is a reference diagram for describing a method of controlling a pointer output on an electronic device, based on movement of a wearable device, according to an embodiment of the disclosure.

FIG. 11 is a reference diagram for describing a method of moving a focus of an electronic device, based on movement of a wearable device, according to an embodiment of the disclosure.

FIG. 12 is a reference diagram for describing a method by which an electronic device obtains a user's preference, according to an embodiment of the disclosure.

FIG. 13 is a reference diagram for describing a process in which an electronic device obtains a priority order for a sub-content genre, according to an embodiment of the disclosure.

FIG. 14 is a reference diagram for describing an operation of an electronic device in a case where priority orders of a focus are the same for a plurality of items in operation 1170, according to an embodiment of the disclosure.

FIG. 15 is a reference diagram for describing an operation according to rotation of an edge part of a display of a wearable device, according to an embodiment of the disclosure.

FIG. 16 is a diagram illustrating a wearable device, an electronic device, a user terminal, and a server, according to an embodiment of the disclosure.

### MODE FOR INVENTION

Various embodiments of the present document and terms used therein are not intended to limit technical features of the present document to particular embodiments, and it is to be appreciated that all changes, equivalents, or substitutes of the embodiments are included therein.

Throughout the specification and drawings, like reference numerals may be used to denote like or similar elements. A singular form of a noun corresponding to an item may include the item or a plurality of the items, unless the context clearly indicates otherwise.

In the present document, the expressions “A or B,” “at least one of A and B,” “at least one of A or B,” “A, B, or C,” “at least one of A, B, and C,” and “at least one of A, B, or C” may include any one of the items listed in the corresponding expression or all possible combinations thereof.

The term “and/or” as used herein includes a combination of a plurality of related recited elements or any one of a plurality of related recited elements.

The terms “first,” “second,” etc. as used herein may be only used to distinguish one element from another and do not limit the elements in any other aspects (e.g., importance or order).

When a certain (e.g., first) element is referred to as being “coupled” or “connected” to another (e.g., second) element with or without the terms “functionally” or “communicatively,” it means that the certain element may be coupled or connected to the other element directly (e.g., by wire) or wirelessly or through a third element.

The terms “comprise” or “include” as used herein are inclusive and therefore specify the presence of stated features, integers, steps, operations, elements, components, or combinations thereof, but do not preclude the presence or addition of one or more other features, integers, steps, operations, elements, components, or combinations thereof.

It will be understood that when an element is referred to as being “connected to,” “coupled to,” “supported to,” or “in contact with” another element, the element may be “directly connected to, coupled to, supported to, or in contact with” the other element or may be “indirectly connected to, coupled to, supported to, or in contact with” the other element through a third element.

It will be understood that when an element is referred to as being located “on” another element, the element may be in contact with the other element, and another element may also be present between the two elements.

It will be understood that blocks of each of flowcharts and combinations of the flowcharts may be performed by one or more computer programs including computer-executable instructions. The one or more computer programs may be all stored in one memory or may be distributed and stored in different memories.

An embodiment of the disclosure may be described in terms of functional block configurations and various processing steps. Some or all of functional blocks may be realized by any number of hardware and/or software configurations configured to perform the specified functions. For example, the functional blocks of the disclosure may be implemented by one or more microprocessors, or may be implemented by circuitry configurations for predetermined functions. In addition, for example, the functional blocks of the disclosure may be implemented with any programming or various scripting languages. The functional blocks may be implemented in algorithms that are executed on one or more processors. Furthermore, the disclosure could employ any number of techniques according to the related art for electronics configuration, signal processing and/or data processing, and the like.

All functions or operations including functions related to artificial intelligence (AI) according to the disclosure operate via a processor and a memory. The processor may refer to one or more processors. One processor or a combination of processors may correspond to circuitry configured to perform processing, and may include circuitry such as an application processor (AP), a communication processor (CP), a graphical processing unit (GPU), a neural processing unit (NPU), a microprocessor unit (MPU), a system on chip (SoC), an integrated chip (IC), or the like.

Hereinafter, the disclosure will now be described in detail with reference to the accompanying drawings.

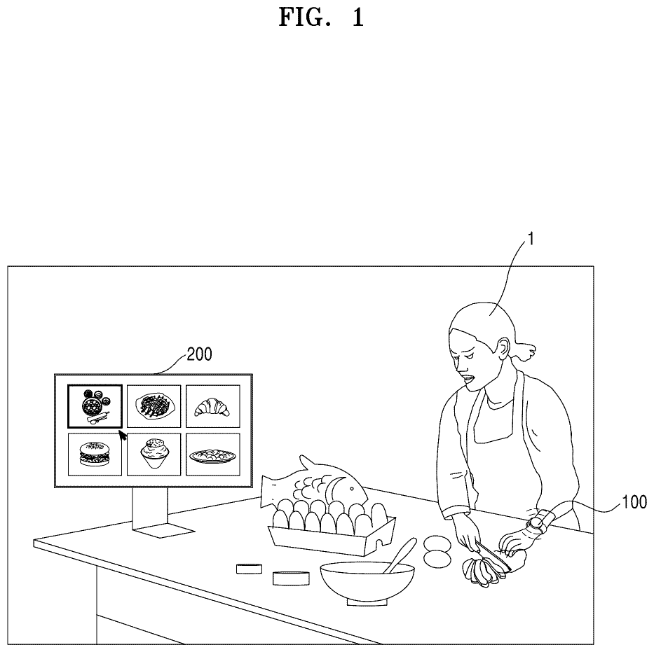

FIG. 1 is a conceptual diagram of a method by which the wearable device 100 and the electronic device 200 operate, according to an embodiment of the disclosure.

According to an embodiment of the disclosure, the wearable device 100 is a device configured to perform various functions according to a request of a user 1. The wearable device 100 may indicate a device implemented as a wearable form that can be worn on a body. For example, the wearable device 100 may include various forms of an electronic device wearable on the user 1, the forms including a smart watch, a smart band, smart glasses, augmented reality (AR)/virtual reality (VR) devices, a smart ring, smart clothing, a wearable sensor, or any other suitable device known to one of ordinary skill in the art.

The wearable device 100 may include a processor and a memory configured to perform one or more functions. The wearable device 100 may detect a motion of the user 1 who is wearing the wearable device 100, may output information, and may be connected to the electronic device 200. For example, the wearable device 100 may monitor a physical activity of the user 1 and may detect a particular motion to remotely control a function of the electronic device 200.

The wearable device 100 may independently operate, or may interoperate with the electronic device 200 so as to provide further extended functions. For example, the user 1 may control the electronic device 200 by using the wearable device 100.

According to an embodiment of the disclosure, the electronic device 200 may be a device capable of displaying an image or data, in response to a request of a user, and may be implemented in various forms. The electronic device 200 may indicate any form of a device including a processor and a memory so as to perform a function. The electronic device 200 may be a stationary device or a mobile device. For example, the electronic device 200 may indicate a device including a display and capable of displaying image content, video content, game content, graphic content, or the like.

The electronic device 200 may include, for example, various types of electronic device capable of receiving and outputting content, such as televisions (TVs) like a network TV, a smart TV, an Internet TV, a web TV, and an Internet Protocol Television (IPTV), computers such as a desktop, a laptop, and a tablet PC, and various types of smart device such as smart monitors, Digital Signage, large displays, 360-degree projectors, smartphones, cellular phones, game players, music players, video players, medical equipment, home appliances, or the like. The electronic device 200 may include various types of electronic device including an air conditioner. The electronic device 200 may be referred to as a display device in view of displaying content, and may also be referred to as a content providing device, a computing device, or the like. In one or more examples the electronic device 200 may be another wearable device.

The electronic device 200 may output various types of content which are provided by contents providers. Content may include a still image, a video such as a moving picture, etc., audio, subtitles, other additional information, or the like. A content provider may refer to a contents production company, a terrestrial broadcaster, a cable broadcaster, satellite broadcaster, an IPTV service provider, or an over-the-top (OTT) service provider which provides various types of content to consumers. The content provider may produce various types of content including dramas, movies, entertainment programs, news, games, audio, or the like.

According to an embodiment of the disclosure, the electronic device 200 may be implemented without a display. For example, the electronic device 200 may be a device that outputs audio. The electronic device 200 may include a set-top box, a desktop PC, etc., which is connectable to a separate external display, but the disclosure is not limited thereto. In this case, the electronic device 200 may be connected to an external display device via an input/output unit such as a high-definition multimedia interface (HDMI) port and may be configured to transmit video/audio signals to the external display device. Alternatively, the electronic device 200 and the external display device may be connected to each other via wired communication, short-range wireless communication such as a wireless local area network (W-LAN), Wi-Fi, Bluetooth, etc., or long-range wireless communication.

According to an embodiment of the disclosure, the wearable device 100 may control the electronic device 200. The wearable device 100 may control the electronic device 200 by using a user input. For example, the wearable device 100 may remotely control the electronic device 200 by using a user input. For example, the wearable device 100 may obtain various user inputs including a touch input, a speech input, a gesture, etc., thereby controlling the electronic device 200. For example, the wearable device 100 may transmit a control signal to the electronic device 200 via a communization interface so as to control the electronic device 200. For example, the wearable device 100 may control the electronic device 200 to select, cancel, play back, pause content, fast forward content, or reverse content. For example, the wearable device 100 may control the electronic device 200 to raise a volume, lower a volume, mute a volume, increase a channel, or decrease a channel.

In order for the wearable device 100 to start control of the electronic device 200, the wearable device 100 may execute a defined graphical user interface element (e.g., a menu, an icon, or an application). When both hands of the user 1 wearing the wearable device 100 are not free, the user 1 may experience difficulty in touching the defined graphical user interface element (e.g., a menu, an icon, or an application). For example, in a situation where the user 1 wearing the wearable device 100 is exercising, cooking, or eating food, it may be difficult for the user 1 to control the wearable device 100 by using user's hands. For example, when the user 1 wearing the wearable device 100 is wearing gloves or has foreign substances on user's hands, it may be impossible or inconvenient to operate the wearable device 100 via a touch. In this case, the user 1 may experience difficulty in starting control of the electronic device 200 by selecting the defined graphical user interface element by manipulating the wearable device 100.

Also, when the wearable device 100 control the electronic device 200, based on a touch input or a keyboard input by the user, the user 1 has to alternately look to the electronic device 200 and the wearable device 100, such that user convenience may deteriorate.

Also, when the wearable device 100 controls the electronic device 200, based on at least one of a motion of the wearable device 100 or a gesture of the user 1, there may be a limit in the number of gestures the wearable device 100 can identify or the user 1 who is wearing the wearable device 100 can easily perform. As function types of the electronic device 200 which may be mapped to gestures of the user wearing the wearable device 100 are limited, the number of functions of the electronic device 200 which may be executed based on a motion or a gesture of the wearable device 100 may be limited.

According to an embodiment of the disclosure, the wearable device 100 may identify a trigger gesture by using at least one sensor (e.g., an acceleration sensor or a gyroscope sensor), and thus, may start control of the electronic device 200. In an embodiment of the disclosure, when the user 1 wearing the wearable device 100 performs a particular gesture, the wearable device 100 may recognize the particular gesture as the trigger gesture, and thus, may start control of the electronic device 200. For example, a trigger gesture may be identified based on data from the acceleration sensor or gyroscope sensor indicating that the wearable device is moved in a predetermined direction at a speed above a predetermined threshold.

According to an embodiment of the disclosure, the wearable device 100 may control the electronic device 200 by identifying a motion of the wearable device 100 or a gesture of the user 1. By doing so, the user may control the electronic device 200 without looking at the wearable device 100, thereby enabling the user to continue a current activity without losing focus such as driving, exercising, cooking, etc. Accordingly, it is possible to provide a user with a more intuitive and convenient user experience. In an embodiment of the disclosure, according to a direction in which the wearable device 100 faces, the wearable device 100 may determine (or, change) an operation of the electronic device 200 which is performed according to a motion of the wearable device 100 or a gesture of a user wearing the wearable device 100. According to an embodiment of the disclosure, the wearable device 100 may determine (or, change) an operation of the electronic device 200 which is performed according to at least one of a direction in which the wearable device faces, a motion of the wearable device 100 or a gesture of a user wearing the wearable device 100. For example, according to directions in which the wearable device 100 faces, the wearable device 100 may control the electronic device 200 to perform different functions even for a same gesture or a same motion. By doing so, the wearable device 100 may control various functions of the electronic device 200, based on a limited number of gestures.

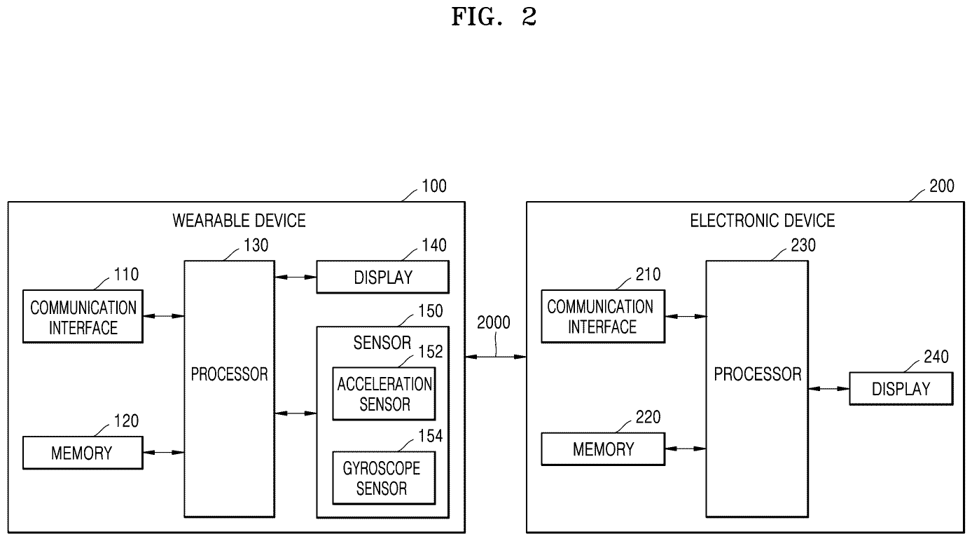

Hereinafter, with reference to FIGS. 2 to 16, a method by which the wearable device 100, according to an embodiment of the disclosure, controls the electronic device 200, the wearable device 100, and the electronic device 200 will now be described in detail.

FIG. 2 is a block diagram illustrating configurations of the wearable device 100 and the electronic device 200 according to an embodiment of the disclosure.

According to an embodiment of the disclosure, the wearable device 100 may include a communication interface 110, a memory 120, a processor 130, a display 140, and a sensor 150. The configuration of the wearable device 100 is not limited to what is shown in FIG. 2, and in one or more embodiments, the wearable device 100 may further include elements not shown in FIG. 2 or some elements may be omitted.

The communication interface 110 may perform communication with at least one electronic device. In one or more examples, the “communication” may refer to an operation of transmitting and/or receiving data, a signal, a request, and/or a command. The communication interface 110 may perform wired or wireless communication with at least one electronic device.

For example, the communication interface 110 may include at least one of a communication module, communication circuitry, a communication device, an input/output port, or an input/output plug for performing wired or wireless communication with at least one electronic device. For example, the communication interface 110 may include at least one wireless communication module, wireless communication circuitry, or a wireless communication device for performing wireless communication with at least one electronic device.

For example, the communication interface 110 may include a short-range communication module such as an infrared (IR) communication module capable of receiving a control command from a remote control device (remote controller) located within a short distance or transmitting a control command to other electronic device. In this case, the communication interface 110 may receive a control signal from the remote control device, or the wearable device 100 as a remote control device may transmit a control signal.

For example, the communication interface 110 may include at least one communication module for performing communication according to a wireless communication standard including Bluetooth low energy (BLE), near-field communication (NFC), radio frequency identification (RFID), Wi-Fi Direct (WFD), ultra-wideband (UWB), ZigBee, or the like. In one or more examples, the communication interface 110 may further include a communication module for performing communication with a server for supporting long-range communication according to a long-range communication standard. For example, the communication interface 110 may include a communication module for performing communication via a network for Internet communication. In one or more examples, the communication interface 110 may include a communication module for performing communication via a communication network that follows a communication standard such as 3^{rd}-generation (3G), 4^{th}-generation (4G), 5^{th}-generation (5G) and/or 6^{th}-generation (6G). For example, the wearable device 100 may communicate with the electronic device 200 via the communication interface 110. For example, the wearable device 100 may communicate with the electronic device 200 via the communication interface 110 (e.g., a Bluetooth communication module) (see reference numeral 2000). For example, the wearable device 100 may communicate with a user terminal by using the communication interface 110 (e.g., a Wi-Fi communication module).

The memory 120 may store a program for processing and controlling by the processor 130, and may store data input to the wearable device 100 or data output from the wearable device 100. Also, the memory 120 may store a plurality of pieces of data required for operations of the wearable device 100.

The memory 120 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc.

The memory 120 may not be separately provided but may be included in the processor 130. The memory 120 may be implemented as a volatile memory, a non-volatile memory, or a combination of a volatile memory and a non-volatile memory. The memory 120 may store a program or at least one instruction for performing operations according to embodiments of the disclosure to be described below. The memory 120 may provide stored data to the processor 130, according to a request of the processor 130.

The processor 130 controls all operations of the wearable device 100. The processor 130 may correspond to a configuration of controlling a series of processes to cause the wearable device 100 to operate according to embodiments to be described below, and may include one or more processors. The one or more processors included in the processor 130 may each correspond to processing circuitry such as a SoC, an IC, or the like.

The one or more processors included in the processor 130 may each be a general-purpose processor such as a central processing unit (CPU), a microprocessor unit (MPU), an application processor (AP), a digital signal processor (DSP), or the like, a graphics-dedicated processor such as a graphics processing unit (GPU), a vision processing unit (VPU) or the like, an AI-dedicated processor such as a neural processing unit (NPU), or a communication-dedicated processor such as a communication processor (CP). When each of the one or more processors included in the processor 130 is an AI-dedicated processor, the AI-dedicated processor may be designed to have a hardware structure specialized for processing of a particular AI model. The processor 130 may be implemented as a single core processor or a multicore processor.

The processor 130 may write data to the memory 120 or may read data stored in the memory 120, and particularly, may execute a program or at least one instruction stored in the memory 120 to process data according to predefined operating rules or an AI model. Therefore, the processor 130 may perform operations to be described in following embodiments of the disclosure, and unless otherwise indicated herein, operations described as being performed by the wearable device 100 or detailed elements included in the wearable device 100 may be understood as being performed by the processor 130.

For example, the processor 130 may individually or collectively execute the at least one instruction stored in the memory 120 to perform functions of the wearable device 100 described in the disclosure. Alternatively, according to an embodiment of the disclosure, the at least one instruction stored in the memory 120, when executed by the processor 130 individually or collectively, may cause the wearable device 100 to perform functions described in the disclosure.

In particular, the processor 130 may execute the program or the at least one instruction stored in the memory 120 to process data according to predefined operating rules or an AI model. Therefore, the processor 130 may perform operations to be described in following embodiments of the disclosure, and unless otherwise indicated herein, operations described as being performed by the wearable device 100 or detailed configurations included in the wearable device 100 may be understood as being performed by the processor 130.

The display 140 may output an image or data processed by the wearable device 100. The display 140 may output an image signal to a screen of the wearable device 100, under the control of the processor 130. For example, the wearable device 100 may output content via the display 140. The display 140 may generate a driving signal by converting an image signal, a data signal, an on-screen display (OSD) signal, and a control signal processed by the processor 130, and may display an image according to the driving signal. The display 140 may include any one display among a liquid-crystal display, a plasma display panel, an organic light-emitting diode display, and an inorganic light-emitting diode display. However, the disclosure is not limited thereto, and the display 140 may include different types of display capable of displaying content.

The sensor 150 may include a plurality of sensors. The sensor 150 may include at least one of an acceleration sensor 152 or a gyroscope sensor 154. The at least one sensor included in the sensor 150 may obtain sensing data. The sensing data obtained by the at least one sensor included in the sensor 150 may be stored in the memory 120. The sensor 150 may transmit the obtained sensing data to the processor 130. The sensor 150 may include at least one of a biometric sensor, a pressure sensor, a geomagnetic sensor, a temperature/humidity sensor, an IR sensor (not shown), a position sensor (e.g., a global positioning system (GPS)) (not shown), a barometric pressure sensor (not shown), or a proximity sensor (not shown), but the disclosure is not limited thereto.

The wearable device 100 may obtain linear acceleration of the wearable device 100 by using the acceleration sensor 152. The linear acceleration may be expressed as unit. The wearable device 100 may obtain acceleration sensing data from the acceleration sensor 152. The wearable device 100 may obtain the linear acceleration of the wearable device 100, based on the acceleration sensing data. The wearable device 100 may obtain at least one of X-axis acceleration sensing data, Y-axis acceleration sensing data, or Z-axis acceleration sensing data. The wearable device 100 may obtain at least one of X-axis acceleration sensing data, Y-axis acceleration sensing data, or Z-axis acceleration sensing data, based on the acceleration sensing data.

The wearable device 100 may obtain angular acceleration of the wearable device 100 by using the gyroscope sensor 154. The angular acceleration may be expressed as rad/s unit. The wearable device 100 may obtain angular acceleration sensing data from the gyroscope sensor 154. The wearable device 100 may obtain angular acceleration of the wearable device 100, based on the angular acceleration sensing data. The wearable device 100 may obtain at least one of X-axis angular acceleration sensing data, Y-axis angular acceleration sensing data, or Z-axis angular acceleration sensing data. The wearable device 100 may obtain at least one of X-axis angular acceleration, Y-axis angular acceleration, or Z-axis angular acceleration, based on the angular acceleration sensing data.

The wearable device 100 may identify a motion of the wearable device 100, based on at least one of the acceleration sensor 152 or the gyroscope sensor 154. The wearable device 100 may identify, based on at least one of the acceleration sensor 152 or the gyroscope sensor 154, a direction in which the wearable device 100 faces. The wearable device 100 may identify a gesture of a user wearing the wearable device 100, based on at least one of the acceleration sensor 152 or the gyroscope sensor 154. Based on at least one of the acceleration sensor 152 or the gyroscope sensor 154, the wearable device 100 may identify at least one of a direction or an angle in which the wearable device 100 is moved.

According to an embodiment of the disclosure, the electronic device 200 may include a communication interface 210, a memory 220, a processor 230, and a display 240. As understood by one of ordinary skill in the art, the configuration of the electronic device 200 is not limited to what is shown in FIG. 2, and in one or more embodiments, the electronic device 200 may further include elements not shown in FIG. 2 or some elements may be omitted.

The communication interface 210 may perform communication with at least one electronic device. Here, the “communication” may refer to an operation of transmitting and/or receiving data, a signal, a request, and/or a command. The communication interface 210 may perform wired or wireless communication with at least one electronic device.

For example, the communication interface 210 may include at least one of a communication module, communication circuitry, a communication device, an input/output port, or an input/output plug for performing wired or wireless communication with at least one electronic device. For example, the communication interface 210 may include at least one wireless communication module, wireless communication circuitry, or a wireless communication device for performing wireless communication with at least one electronic device.

For example, the communication interface 210 may include a short-range communication module such as an infrared (IR) communication module capable of receiving a control command from a remote control device (remote controller) located within a short distance. In this case, the communication interface 210 may receive a control signal from the remote control device.

For example, the communication interface 210 may include at least one communication module for performing communication according to a wireless communication standard including BLE, NFC, RFID, WFD, UWB, ZigBee, or the like. Alternatively, the communication interface 210 may further include a communication module for performing communication with a server for supporting long-range communication according to a long-range communication standard. For example, the communication interface 210 may include a communication module for performing communication via a network for Internet communication. Also, the communication interface 210 may include a communication module for performing communication via a communication network that follows a communication standard such as 3G, 4G, 5G and/or 6G. For example, the electronic device 200 may communicate with the wearable device 100 via the communication interface 210 (e.g., a Bluetooth communication module) (see reference numeral 2000). For example, the electronic device 200 may communicate with a user terminal by using the communication interface 210 (e.g., a Wi-Fi communication module).

The memory 220 may store a program for processing and controlling by the processor 230, and may store data input to the electronic device 200 or data output from the electronic device 200. Also, the memory 220 may store a plurality of pieces of data required for operations of the electronic device 200.

The memory 220 may include at least one type of storage medium from among flash memory, a hard disk, a multimedia card micro, a memory card (e.g., a SD or XD memory card), RAM, SRAM, ROM, EEPROM, PROM, magnetic memory, a magnetic disk, and an optical disc.

The memory 220 may not be separately provided but may be included in the processor 230. The memory 220 may be implemented as a volatile memory, a non-volatile memory, or a combination of a volatile memory and a non-volatile memory. The memory 220 may store a program or at least one instruction for performing operations according to embodiments of the disclosure to be described below. The memory 220 may provide stored data to the processor 230, according to a request of the processor 230.

The processor 230 controls all operations of the electronic device 200. The processor 230 may correspond to a configuration of controlling a series of processes to cause the electronic device 200 to operate according to embodiments to be described below, and may include one or more processors. The one or more processors included in the processor 230 may each correspond to processing circuitry such as a SoC, an IC, or the like.

The one or more processors included in the processor 230 may each be a general-purpose processor such as a CPU, a MPU, an AP, a DSP, or the like, a graphics-dedicated processor such as a GPU, a VPU or the like, an AI-dedicated processor such as a NPU, or a communication-dedicated processor such as a CP. When each of the one or more processors included in the processor 230 is an AI-dedicated processor, the AI-dedicated processor may be designed to have a hardware structure specialized for processing of a particular AI model. The processor 230 may be implemented as a single core processor or a multicore processor.

The processor 230 may write data to the memory 220 or may read data stored in the memory 220, and particularly, may execute a program or at least one instruction stored in the memory 220 to process data according to predefined operating rules or an AI model. Therefore, the processor 230 may perform operations to be described in following embodiments of the disclosure, and unless otherwise indicated herein, operations described as being performed by the electronic device 200 or detailed elements included in the electronic device 200 may be understood as being performed by the processor 230.

For example, the processor 230 may individually or collectively execute the at least one instruction stored in the memory 220 to perform functions of the electronic device 200 described in the present document. Alternatively, according to an embodiment of the disclosure, the at least one instruction stored in the memory 220, when executed by the processor 230 individually or collectively, may cause the electronic device 200 to perform functions described in the present document.

In particular, the processor 230 may execute the program or the at least one instruction stored in the memory 220 to process data according to predefined operating rules or an AI model. Therefore, the processor 230 may perform operations to be described in following embodiments of the disclosure, and unless otherwise indicated herein, operations described as being performed by the electronic device 200 or detailed configurations included in the electronic device 200 may be understood as being performed by the processor 230.

The display 240 may output an image or data processed by the electronic device 200. The display 240 may output an image signal to a screen of the electronic device 200, under the control of the processor 230. For example, the electronic device 200 may output content via the display 240. The display 240 may generate a driving signal by converting an image signal, a data signal, an OSD signal, and a control signal processed by the processor 230, and may display an image according to the driving signal. The display 240 may include any one display among a liquid-crystal display, a plasma display panel, an organic light-emitting diode display, and an inorganic light-emitting diode display. However, the disclosure is not limited thereto, and the display 240 may include different types of display capable of displaying content.

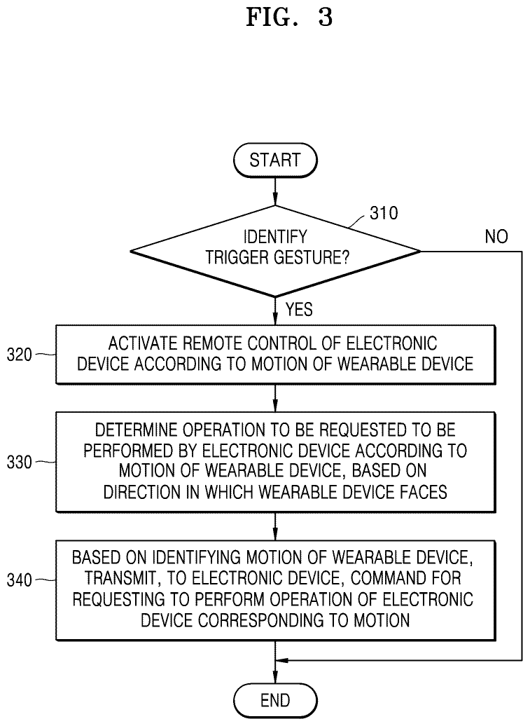

FIG. 3 is a flowchart for describing operations of the wearable device 100 according to an embodiment of the disclosure.

Referring to FIG. 3, an operating method of the wearable device 100 may include operation 310 to operation 340. In an embodiment of the disclosure, operation 310 to operation 340 may be executed by at least one processor included in the wearable device 100. The operating method of the wearable device 100 is not limited to what is shown in FIG. 3, and in one or more embodiments of the disclosure, the operating method may further include operations not shown in FIG. 3 or some operations may be skipped.

Referring to operation 310, the wearable device 100 may identify a trigger gesture. The wearable device 100 may identify a trigger gesture using at least one sensor that detects a first motion of the wearable device 100. The wearable device 100 may identify the trigger gesture by using at least one sensor. For example, the wearable device 100 may identify the trigger gesture by using an acceleration sensor. For example, the wearable device 100 may identify the trigger gesture by using at least one of the acceleration sensor or a gyroscope sensor. For example, a trigger gesture may be identified based on a user moving a wearable device in an upward direction at a distance greater than equal to a distance threshold and/or at a speed greater than or equal to a speed threshold.

The trigger gesture may indicate a gesture for activating remote control of the electronic device 200 by using the wearable device 100. The trigger gesture may indicate a gesture for activating (or, starting) an interaction between the wearable device 100 and the electronic device 200. For example, when the wearable device 100 identifies the trigger gesture of a user who is wearing the wearable device 100, the wearable device 100 may activate remote control of the electronic device 200, the remote control being performed using the wearable device 100. For example, the wearable device 100 may switch to a remote control mode of the electronic device 200. For example, the wearable device 100 may activate a pointer mode for controlling the electronic device 200, based on a motion of the wearable device 100. In one or more examples, when remote control of the electronic device 200, the electronic device 200 may provide an indication that the remote control function is activated. For example, the electronic device 200 may adjust a brightness of a display of the electronic device 200 or may flash an icon on the display of the electronic device 200 to indicate that the remote control function is activated.

In an embodiment of the disclosure, the trigger gesture may indicate a predetermined (or, defined) gesture. For example, the wearable device 100 may identify whether a gesture identified based on sensing data obtained from at least one of the acceleration sensor or the gyroscope sensor corresponds to the predetermined (or, defined) gesture. For example, the wearable device 100 may input the sensing data obtained from at least one of the acceleration sensor or the gyroscope sensor to an AI model, and may identify whether the identified gesture corresponds to the predetermined (or, defined) gesture. When the gesture identified based on the sensing data obtained from at least one of the acceleration sensor or the gyroscope sensor corresponds to the predetermined (or, defined) gesture, the wearable device 100 may activate remote control of the electronic device 200, the remote control being performed using the wearable device 100.

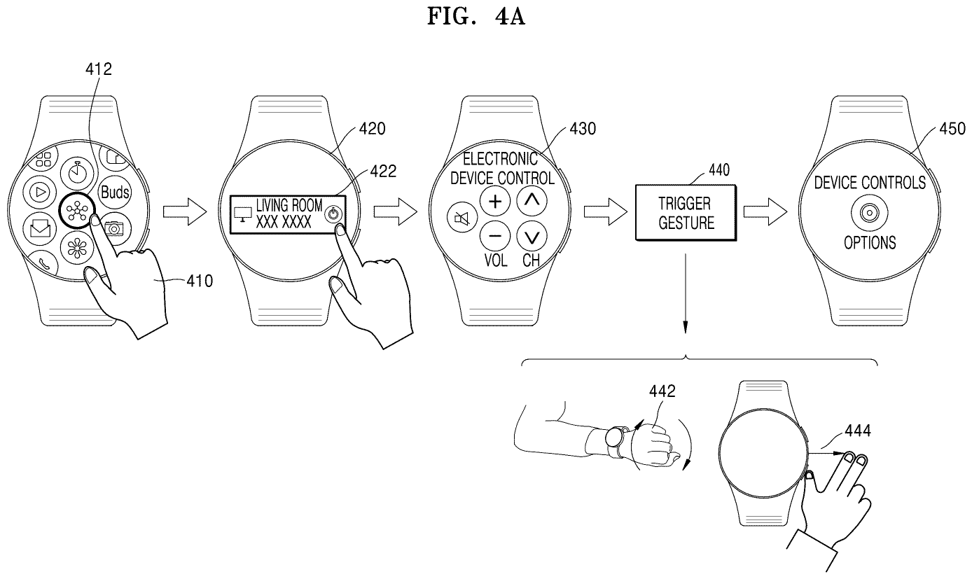

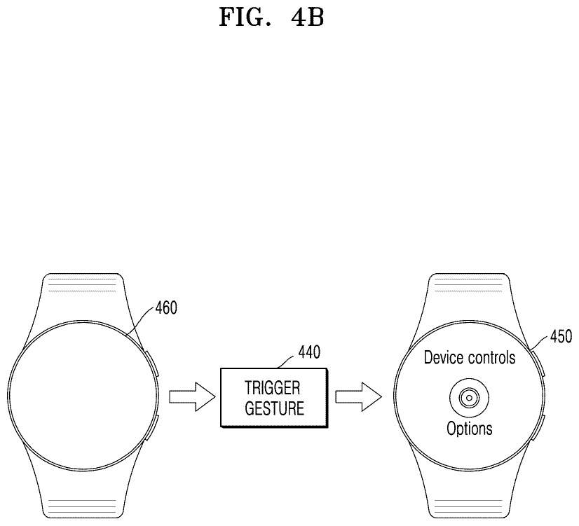

Referring to operation 320, when the wearable device 100 identifies the trigger gesture, the wearable device 100 may activate the remote control of the electronic device 200. For example, based on the wearable device 100 identifying the trigger gesture, the wearable device 100 may activate the remote control of the electronic device 200 according to a motion of the wearable device 100. An operation in which the wearable device 100 identifies the trigger gesture and activates the remote control of the electronic device 200 will be described in detail with reference to FIGS. 4A and 4B.

Referring to operation 330, the wearable device 100 may identify a direction in which the wearable device 100 faces. For example, the wearable device 100 may identify the direction in which a front face of a display of the wearable device 100 faces. For example, the wearable device 100 may identify a direction in which the back of a hand of a user who is wearing the wearable device 100 faces. For example, the wearable device 100 may identify an angle between the ground and the back of the hand of the user wearing the wearable device 100.

According to an embodiment of the disclosure, the wearable device 100 may determine an operation of the electronic device 200 to be performed according to the direction that the wearable device 100 faces and a second motion of the wearable device. Based on the direction in which the wearable device 100 faces, the wearable device 100 may determine an operation that the wearable device 100 requests or commands the electronic device 200 to perform according to a motion of the wearable device 100. For example, based on the direction in which the wearable device 100 faces, the wearable device 100 may determine an operation to be requested to be performed by the electronic device 200 according to a direction in which the wearable device is moved.

For example, based on the direction in which the wearable device 100 faces (e.g., a direction in which the display of the wearable device 100 faces), the wearable device 100 may determine whether to request the electronic device 200 to change a position of a pointer (or, a cursor) output on a display of the electronic device 200, or whether to request the electronic device 200 to change a focus output on the display of the electronic device 200, according to the direction in which the wearable device is moved (e.g., a direction in which a user's wrist on which the wearable device 100 is worn is moved). For example, when the wearable device 100 (e.g., the display of the wearable device 100) faces a first direction or a third direction, the wearable device 100 may request (or, transmit a request command) the electronic device 200 to change the position of the pointer output on the display of the electronic device 200, according to a movement direction of the user's wrist on which the wearable device is worn. For example, when the wearable device 100 (e.g., the display of the wearable device 100) faces a second direction, the wearable device 100 may request (or, transmit a request command) the electronic device 200 to change the focus output on the display of the electronic device 200, according to a movement direction of the user's wrist on which the wearable device is worn. In one or more examples, the motion corresponding to a trigger gesture may be different than the motion corresponding to an operation that the wearable device 100 requests or commands the electronic device 200 to perform.

In one or more examples, based on a direction in which the wearable device 100 faces (e.g., the direction in which the display of the wearable device 100 faces), the wearable device 100 may change an operation (or, a function) to be requested for the wearable device 100 to perform according to a gesture of the user wearing the wearable device 100.

For example, based on a direction in which the wearable device 100 faces (e.g., the direction in which the display of the wearable device 100 faces), the wearable device 100 may determine (or, select) a type of a gesture mapping table in which operations (or, functions) to be requested for the electronic device 200 to perform according to gestures of the user wearing the wearable device 100 are mapped. For example, based on the direction in which the display of the wearable device 100 faces, the wearable device 100 may determine (or, select) the gesture mapping table in which operations (or, functions) to be requested for the electronic device 200 to perform according to gestures of the user wearing the wearable device 100 are mapped.

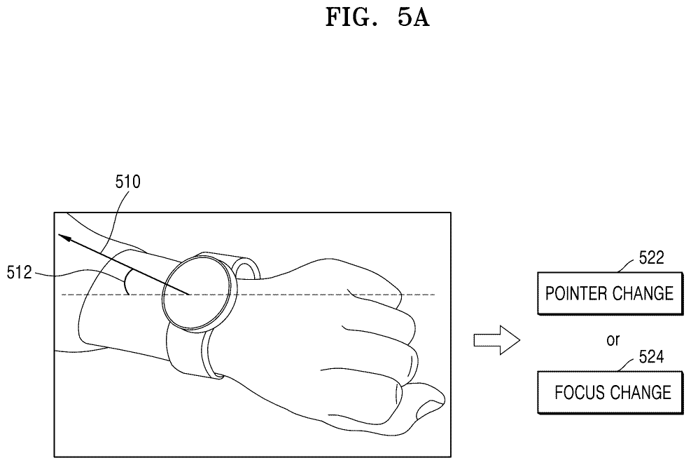

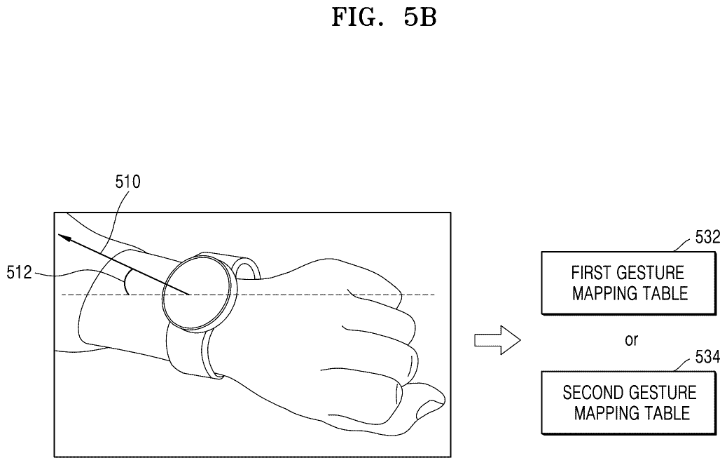

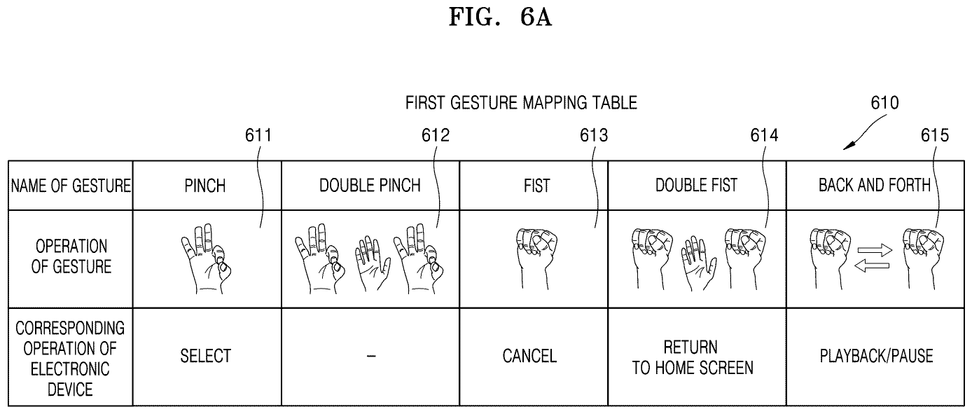

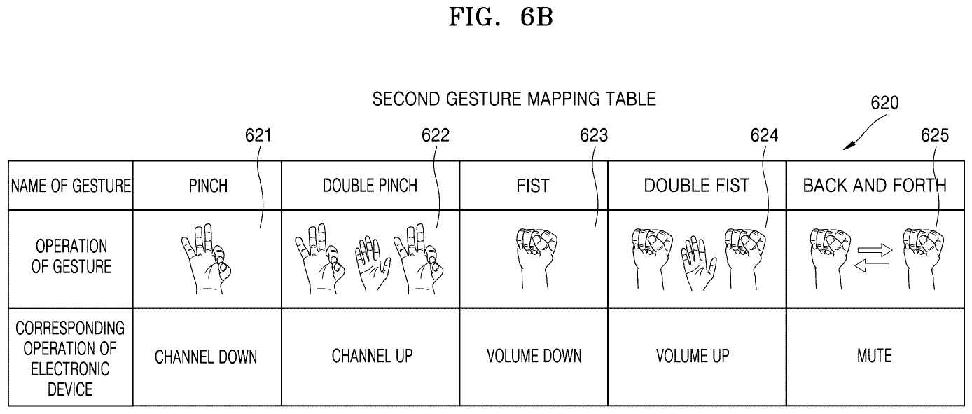

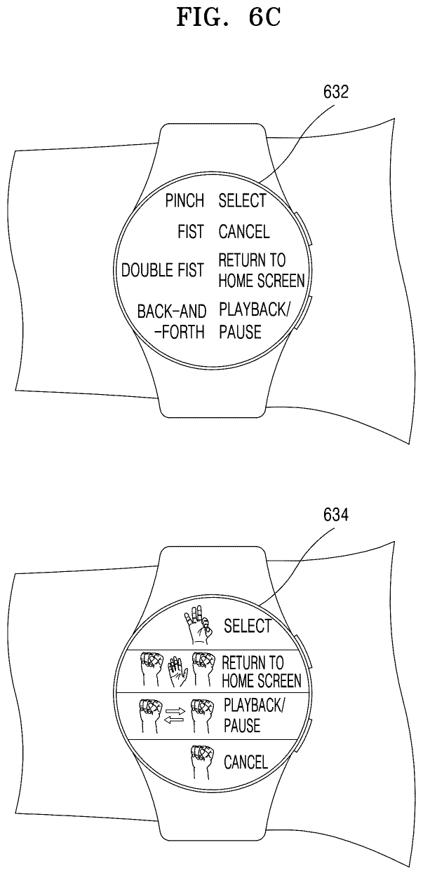

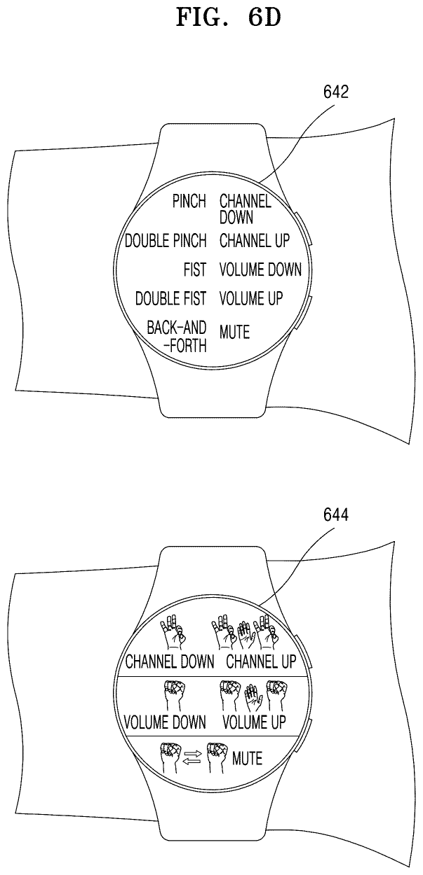

For example, based on the direction in which the wearable device 100 faces, the wearable device 100 may determine (or, select) the type of the gesture mapping table to be a second gesture mapping table in which a gesture of the user wearing the wearable device 100 is mapped to a command for requesting a change of at least one of a channel of the electronic device 200 or a volume of the electronic device 200. For example, based on the direction in which the wearable device 100 faces, the wearable device 100 may determine (or, select) the type of the gesture mapping table to be a first gesture mapping table in which a gesture of the user wearing the wearable device 100 is mapped to a command for requesting to perform at least one function of the electronic device, from among of an item selection function, an item cancellation function, a return-to-home screen function, or a playback/pause function. Operation 330 will be described in detail with reference to FIGS. 5, 6A, and 6B.

Referring to operation 340, the wearable device 100 may identify the motion of the wearable device 100. According to an embodiment of the disclosure, the wearable device 100 may transmit, to the electronic device 200, a command for requesting the electronic device 200 to perform an operation corresponding to the identified motion.

In an embodiment of the disclosure, the wearable device 100 may identify a direction in which the wearable device 100 is moved, by using at least one of the acceleration sensor or the gyroscope sensor. The wearable device 100 may identify, based on sensing data obtained by using at least one of the acceleration sensor or the gyroscope sensor, a direction in which the wearable device 100 is moved.

In an embodiment of the disclosure, the wearable device 100 may transmit, to the electronic device 200, a command for requesting to change a focus or a position of a pointer, in response to the identified direction in which the wearable device 100 is moved. In an embodiment of the disclosure, the wearable device 100 may control the electronic device 200 to change the focus or the position of the pointer, in response to the identified direction in which the wearable device 100 is moved. Based on determining whether to change the position of the pointer or the focus in operation 330, the wearable device 100 may control the electronic device 200 to change the position of the pointer or the focus of the electronic device 200, in response to the identified direction in which the wearable device 100 is moved.

In an embodiment of the disclosure, the wearable device 100 may identify, based on sensing data obtained from the acceleration sensor, a gesture of the user who is wearing the wearable device 100. For example, the wearable device 100 may input the sensing data obtained from the acceleration sensor into an AI model, and thus, may identify the gesture of the user wearing the wearable device 100. For example, the wearable device 100 may identify at least one gesture of the user wearing the wearable device 100, from among gestures including a pinch gesture, a double pinch gesture, a fist gesture, a double fist gesture, or a back-and-forth gesture.

In an embodiment of the disclosure, the wearable device 100 may transmit, to the electronic device 200, a command for requesting the electronic device 200 to perform an operation corresponding to the gesture, based on a determined type of a gesture mapping table.

FIGS. 4A and 4B are reference diagrams for describing an operation in which the wearable device 100 activates remote control of the electronic device 200, according to an embodiment of the disclosure.

According to an embodiment of the disclosure, a memory of the wearable device 100 may have stored therein a program (e.g., an application) for controlling the electronic device 200 and/or an external electronic device. The wearable device 100 may be sold in a state in which the program (e.g., the application) for controlling the electronic device 200 and/or an external electronic device is installed (e.g., preloaded) in the memory or is not installed in the memory. When the wearable device 100 is sold in a state in which the application for controlling the electronic device 200 and/or an external electronic device is not installed, a user may download the application from an external server providing the application and may install the application in the wearable device 100.

The user may control the electronic device 200 by using an application 412 installed in the wearable device 100. For example, when the user selects the application 412 installed in the wearable device 100 (operation 410), the wearable device 100 may execute the application. When the wearable device 100 executes the application, a plurality of pieces of identification information of a plurality of electronic devices connected to the same user account of the wearable device 100 may be output on an application execution screen 420. For example, when the wearable device 100 executes the application, the wearable device 100 may output, to the application execution screen 420, identification information 422 of the electronic device 200 connected to the same user account of the wearable device 100. In one or more examples, one or more gesture mapping tables may be associated with a user account. For example, two different users with separate accounts may be associated with different gesture mapping tables. In one or more examples, a user may customize a gesture mapping table based on a preference of the user.

In an embodiment of the disclosure, the wearable device 100 may obtain a user input of selecting the identification information 422 of the electronic device 200 from the application execution screen. The wearable device 100 may obtain the user input of selecting the identification information 422 of the electronic device 200 from the application execution screen 420, and thus, may perform control with respect to the electronic device 200. The wearable device 100 may obtain the user input of selecting the identification information 422 of the electronic device 200 from the application execution screen 420, and thus, may output a touch control window 430 for controlling the electronic device 200 to the application execution screen. When the wearable device 100 obtains the user input of selecting the identification information 422 of the electronic device 200 from the application execution screen 420, the wearable device 100 may activate a sensor 150. Therefore, the wearable device 100 may decrease an unnecessary operation of the sensor 150 by activating the sensor only when needed, and thus, may optimize power consumption.

When the user inputs a control command with respect to the electronic device 200 via the touch control window 430, the wearable device 100 may directly transmit the control command to the electronic device 200 via a short-range network or may transmit the control command to the electronic device 200 by passing through a server.

The application of the wearable device 100 may receive various user inputs for controlling the electronic device 200 and/or the external electronic device. The application provides a graphical user interface (GUI) for receiving various user inputs, and receives a user input via the GUI. While communicating with the server, the wearable device 100 may update state information of the electronic device 200, and may provide the updated state information to the server via the application. Also, while communicating with the server, the wearable device 100 may transmit, to the electronic device 200, a user input received from the server via the application. While directly communicating with the electronic device 200, the wearable device 100 may update state information of the electronic device 200, and may provide the updated state information to the electronic device 200 via the application. While directly communicating with the electronic device 200, the wearable device 100 may transmit, to the electronic device 200, a user input received via the application. The state information of the electronic device (200) may include at least one of a power on/off state, a normal operation state, an activation state, or a remaining battery percentage.

The application may receive a power off signal or a power-off reservation signal of the electronic device 200. Also, the application may receive a reservation setting signal of the electronic device 200, and may receive a user input of setting a scheduled power-off time. The application may receive at least one of a volume or a channel of the electronic device 200. The application may receive a user input of changing at least one of the volume or the channel of the electronic device 200. For example, the application may receive a user input of muting a volume of the electronic device 200, lowering the volume, or raising the volume. For example, the application may receive a user input of increasing a channel of the electronic device 200 or decreasing the channel. For example, the application may receive, with respect to the electronic device 200, a user input of selecting an item, cancelling selection, returning to home screen, playing back content, or pausing playback of content.

According to an embodiment of the disclosure, the wearable device 100 may start (or, activate) remote control of the electronic device 200, the remote control being performed according to a motion (e.g. the first motion) of the wearable device 100. For example, the wearable device 100 may enter a pointing mode for controlling the electronic device 200 according to a motion (e.g. the first motion) of the wearable device 100. In an embodiment of the disclosure, the wearable device 100 may identify a trigger gesture 440 indicating a gesture for starting the remote control of the electronic device 200 according to a motion (e.g. the first motion) of the wearable device 100.

According to an embodiment of the disclosure, when the wearable device 100 identifies the trigger gesture 440 in a state where an application is being executed, the wearable device 100 may start the remote control of the electronic device 200 according to a motion of the wearable device 100. The trigger gesture 440 may include at least one of a wrist shaking gesture 442 or a gesture 444 of swiping a display (or, a display screen). The state where the application is being executed may include at least one of a state where the application is activated, a state where the application is output on the display (or, the display screen), or a state where the application is executed in the background.

For example, the wearable device 100 may identify the gesture 444 of swiping the display (or, the display screen). When the wearable device 100 identifies the gesture 444 of swiping the display (or, the display screen), the remote control of the electronic device 200 according to a motion of the wearable device 100 may start. According to an embodiment of the disclosure, when the wearable device 100 detects, via a touch sensor, the gesture 444 of horizontally or vertically swiping the display (or, the display screen), the remote control of the electronic device 200 according to a motion of the wearable device 100 may start. When the remote control of the electronic device 200 according to a motion of the wearable device 100 starts, the wearable device 100 may output a motion control window 450 to an application execution screen.

When the wearable device 100 detects the gesture 444 of swiping the display (or, the display screen), the wearable device 100 may activate at least one sensor (e.g., an acceleration sensor or a gyroscope sensor). The wearable device 100 may identify a motion of the wearable device 100, based on sensing data obtained from the activated at least one sensor.

In an embodiment of the disclosure, the wearable device 100 may identify a gesture in which a user wearing the wearable device 100 shakes a wrist. For example, the gesture in which the user wearing the wearable device 100 shakes the wrist may be substituted with at least one of a gesture in which the user wearing the wearable device 100 rapidly shakes the wrist, a gesture in which the user wearing the wearable device 100 shakes the wrist at least once, or a shake gesture. Hereinafter, the gesture in which the user wearing the wearable device 100 shakes the wrist is referred to and described as a wrist shaking gesture.

In an embodiment of the disclosure, the wearable device 100 may identify (or, recognize or detect) the wrist shaking gesture by using at least one sensor. For example, the wearable device 100 may identify (or, recognize or detect) the wrist shaking gesture, based on sensing data obtained from the at least one sensor. For example, the wearable device 100 may identify (or, recognize or detect) the wrist shaking gesture by using at least one of the acceleration sensor or the gyroscope sensor.

The wearable device 100 may identify the wrist shaking gesture by identifying a variation in an acceleration value included in acceleration sensing data during a defined time period. For example, the wearable device 100 may obtain at least one of X-axis acceleration sensing data, Y-axis acceleration sensing data, or Z-axis acceleration sensing data, based on the acceleration sensing data obtained from the acceleration sensor. For example, when the wearable device 100 identifies that at least one of the X-axis acceleration sensing data, the Y-axis acceleration sensing data, or the Z-axis acceleration sensing data changes more than a defined number of times (e.g., 2 times) and exceeds a threshold range (e.g., 5 m/s² or more), the wearable device 100 may identify the wrist shaking gesture. For example, when the wearable device 100 identifies that at least one of the X-axis acceleration sensing data, the Y-axis acceleration sensing data, or the Z-axis acceleration sensing data repeatedly changes during a defined time period (e.g., 0.5 seconds), the wearable device 100 may identify the wrist shaking gesture.

According to an embodiment of the disclosure, when the wearable device 100 identifies the wrist shaking gesture 442, the remote control of the electronic device 200 according to a motion of the wearable device 100 may start. According to an embodiment of the disclosure, when the wearable device 100 identifies the wrist shaking gesture 442, based on sensing data obtained from at least one of the acceleration sensor or the gyroscope sensor, the wearable device 100 may start the remote control of the electronic device 200 according to a motion of the wearable device 100. When the remote control of the electronic device 200 according to a motion of the wearable device 100 starts, the wearable device 100 may output the motion control window 450 to an application execution screen.

When the wearable device 100 detects the wrist shaking gesture 442, the wearable device 100 may activate at least one sensor (e.g., the acceleration sensor or the gyroscope sensor). The wearable device 100 may identify a motion of the wearable device 100 by using the activated at least one sensor.

By doing so, the wearable device 100 may activate control of the electronic device 200 according to a motion of the wearable device 100 in a hands-free manner without touching a display or clicking a button, so that a user experience may be improved. For example, in a situation where it is difficult for a user to use hands, the user may activate control of the electronic device 200 according to a motion of the wearable device 100 via a wrist shaking gesture, so that user convenience may be improved.

Referring to FIG. 4B, in an embodiment of the disclosure, when the wearable device 100 identifies the trigger gesture 440, the wearable device 100 may start the remote control of the electronic device 200 according to a motion of the wearable device 100. Even in a state where an application is not being executed, when the wearable device 100 identifies the trigger gesture 440, the wearable device 100 may start the remote control of the electronic device 200 according to a motion of the wearable device 100. In one or more examples, the application executed by the wearable device 100 may be executed in the background. Therefore, even though the application may not be visible, the trigger gesture may still be recognized.

In an embodiment of the disclosure, when the electronic device 200 is the only electronic device which is connected to the application, the wearable device 100 may start the remote control of the electronic device 200 according to a motion of the wearable device 100, by identifying the trigger gesture 440 even in a state where an application is not being executed or is executed but not visible (see reference numeral 460). The state where an application is not being executed (460) may include at least one of a state in which the application is deactivated, a state in which the application is not executed in the background, or a state in which another application is executed. Descriptions of the trigger gesture 440, an application, and remote control which overlap those of FIG. 4A are not provided here.

FIG. 5A is a reference diagram for describing a process of selecting an operation to be performed in the electronic device 200 according to a motion of a wrist of a user wearing the wearable device 100 according to a direction in which the wearable device 100 faces, according to an embodiment of the disclosure.

According to an embodiment of the disclosure, the wearable device 100 may identify a direction in which the wearable device 100 faces. For example, the wearable device 100 may identify a direction 510 in which a display of the wearable device 100 faces. For example, the wearable device 100 may identify the direction 510 in which a front face of the display of the wearable device 100 faces. For example, the wearable device 100 may identify an angle 512 between the ground and the front face of the display of the wearable device 100. For example, the wearable device 100 may identify a direction in which the back of a hand of a user who is wearing the wearable device 100 faces. For example, the wearable device 100 may identify an angle between the ground and the back of the hand of the user. In a case where the wearable device 100 is a smart watch, the front face of the display may indicate a watch face.

The wearable device 100 may identify a direction in which the wearable device 100 faces, by using at least one sensor (e.g., based on sensing data obtained from the at least one sensor). For example, the wearable device 100 may identify a direction in which the wearable device 100 faces, by using at least one of the acceleration sensor or the gyroscope sensor (e.g., based on sensing data obtained from at least one of the acceleration sensor or the gyroscope sensor). For example, the wearable device 100 may obtain an angle between the wearable device 100 and the ground by identifying a gravity direction by using the acceleration sensor (e.g., based on acceleration sensing data obtained from the acceleration sensor). For example, the wearable device 100 may identify a sudden directional change and angular acceleration of the wearable device 100 by identifying a rotation speed of the wearable device 100 by using the gyroscope sensor (e.g., based on gyroscope sensing data obtained from the gyroscope sensor), and thus, may identify a direction in which the wearable device 100 faces.

According to an embodiment of the disclosure, the wearable device 100 may determine an operation to be requested to be performed by the electronic device 200 according to a motion (e.g. the second motion) of the wearable device 100, based on a direction in which the wearable device 100 faces. For example, the wearable device 100 may determine an operation to be requested to be performed by the electronic device 200 according to the direction in which the wearable device faces and the second motion of the wearable device 100. For example, the wearable device 100 may determine an operation to be requested to be performed by the electronic device 200 according to a direction or an angle in which the wearable device 100 is moved, based on the direction in which the wearable device 100 faces.

For example, according to the direction in which the wearable device 100 faces, the wearable device 100 may determine to transmit, to the electronic device 200, a command for requesting a change 522 in a position of a pointer output on a display of the electronic device 200 based on a motion of the wearable device 100. For example, the wearable device 100 may determine to transmit, to the electronic device 200, a command for requesting a change 522 in a position of a pointer output on a display of the electronic device 200 based on a motion of the wearable device 100 and the direction in which the wearable device 100 faces. For example, a motion of the wearable device 100 may indicate a motion of a wrist of the user who is wearing the wearable device 100.

For example, when the wearable device 100 identifies the direction in which the wearable device 100 faces as a first direction or a third direction, based on a motion of the wearable device 100, the wearable device 100 may determine to transmit, to the electronic device 200, a command for requesting the change 522 (e.g., control) in the position of the pointer (or, a cursor) output on the display of the electronic device 200. When the wearable device 100 identifies the direction in which the wearable device 100 faces as the first direction or the third direction, the wearable device 100 may identify (or, recognize or interpret) the motion of the wearable device 100 as a command of moving the pointer (or, the cursor) of the wearable device 100.

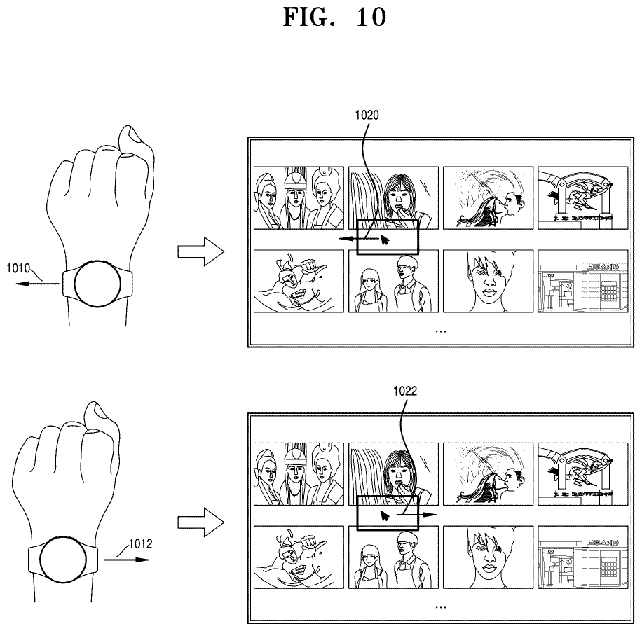

For example, the wearable device 100 may determine to transmit, to the electronic device 200, a command for requesting the change 522 (e.g., control) in a position of the pointer output on the display of the electronic device 200, based on a direction in which the wearable device 100 is moved. For example, the wearable device 100 may determine to transmit, to the electronic device 200, a command for requesting the change 522 (e.g., control) in a position of the pointer output on the display of the electronic device 200, based on a direction or a degree (or, distance) in which the wearable device 100 is moved. For example, the wearable device 100 may determine to transmit, to the electronic device 200, a command for requesting the change 522 (e.g., control) in a position of the pointer output on the display of the electronic device 200, based on a direction and speed in which the wearable device 100 is moved. An embodiment of the disclosure in which the wearable device 100 controls a position of the pointer output on the display of the electronic device 200 will be described in detail with reference to FIG. 10.

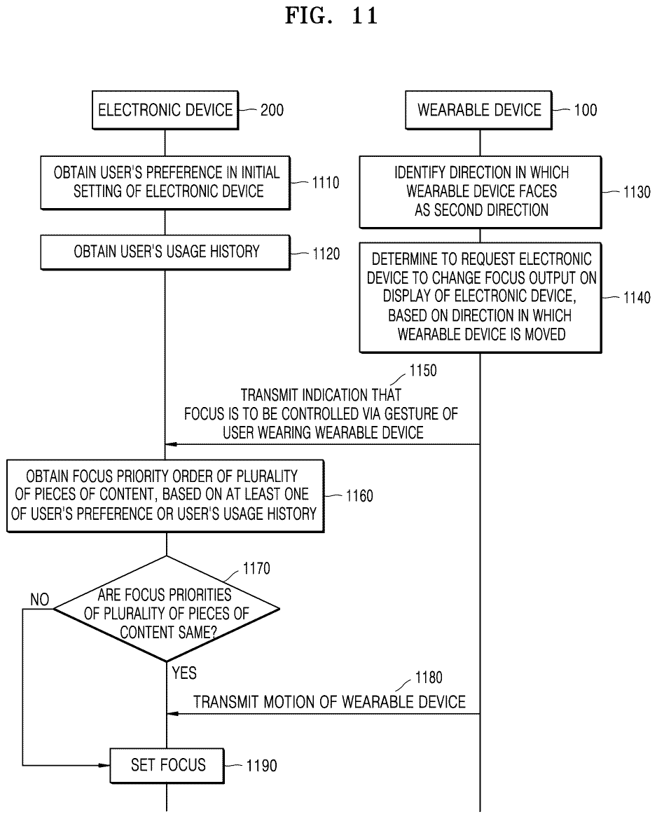

According to an embodiment of the disclosure, according to a direction in which the wearable device 100 faces, the wearable device 100 may determine to transmit, to the electronic device 200, a command for requesting the change 522 (e.g., control) in a position of a focus output on the display of the electronic device 200 based on a direction and a degree in which the wearable device 100 is moved. For example, when the wearable device 100 identifies a direction in which the wearable device 100 faces as a second direction, the wearable device 100 may determine to transmit, to the electronic device 200, a command for requesting a change 524 (e.g., control) in the focus output on the display of the electronic device 200, based on a direction or at least one of an angle or a degree of a motion (level of motion) in which the wearable device 100 is moved. According to an embodiment of the disclosure, the wearable device 100 may determine to transmit, to the electronic device 200, a command for requesting the change 524 in a position of a focus output on the display of the electronic device 200 based on a direction in which the wearable device 100 is moved and a direction in which the wearable device 100 faces. When the wearable device 100 identifies the direction in which the wearable device 100 faces as the second direction, a motion of the wearable device 100 may be identified as a focus movement command for the electronic device 200. An embodiment of the disclosure in which the wearable device 100 controls the focus output on the display of the electronic device 200 will be described in detail with reference to FIGS. 11 to 15.

In this manner, according to a direction in which the wearable device 100 faces, the wearable device 100 may control various functions of the electronic device 200 via the wearable device 100 by selecting (or, changing or mapping) a function of the electronic device 200 to be controlled based on a direction in which the wearable device 100 is moved. For example, as it is possible to map all of an operation of changing a position of a pointer of the electronic device 200 and an operation of changing a focus to a single gesture in which a user wearing the wearable device 100 is moved the wearable device 100, the wearable device 100 may control a plurality of functions of the electronic device 200 by one gesture. By doing so, the user of the wearable device 100 may effectively control various functions of the electronic device 200 by a simple motion (e.g., motion with minimal movement), so that a more intuitive user experience may be provided.

FIG. 5B is a reference diagram for describing a process of selecting a gesture mapping table in which functions of the electronic device 200 are mapped according to gestures of a user according to a direction in which the wearable device 100 faces, the user being wearing the wearable device 100, according to an embodiment of the disclosure.

In an embodiment of the disclosure, the wearable device 100 may determine a command to be performed by the electronic device 200 according to a gesture of the user wearing the wearable device 100, based on a direction in which the wearable device 100 faces. The wearable device 100 may select (or, identify) an appropriate gesture mapping table that is predefined rule set according to directions in which the wearable device 100 faces.

The wearable device 100 or the electronic device 200 may select a mapping table.

The wearable device 100 may select a gesture mapping table, based on information of a direction in which the wearable device 100 faces. In this case, the wearable device 100 may identify a gesture and then may identify a control command corresponding to the gesture identified from the gesture mapping table. The wearable device 100 may transmit the identified control command to the electronic device 200 so as to control the electronic device 200 to perform an operation or a function corresponding to the control command.

As the gesture mapping table is selected from the electronic device 200 based on the information of the direction in which the wearable device 100 faces, the wearable device 100 may provide the electronic device 200 with information of a direction in which the wearable device 100 faces. In this case, identifying of the gesture may be performed by the wearable device 100 or the electronic device 200. When the wearable device 100 identifies the gesture, the wearable device 100 may transmit information of the identified gesture to the electronic device 200. The electronic device 200 may determine, based on the selected table, an operation or a function to perform, based on the information of the gesture received from the wearable device 100.

The electronic device 200 may identify a gesture of the user. The wearable device 100 may provide motion information (information of a direction and motion degree) to the electronic device 200. The electronic device 200 may identify a gesture of the user, based on the motion information received from the wearable device 100. The electronic device 200 may determine an operation or a function to perform, based on a gesture mapping table selected according to the identified gesture and the information of the direction in which the wearable device 100 faces.

The gesture mapping table may indicate a table in which mapping rules for connecting predefined gestures (e.g., pinch gesture, double pinch gesture, back-and-forth gesture) performed by a user who is wearing the wearable device 100, and operations (or, functions) (e.g., selection, cancellation, volume increase) of the electronic device 200 which correspond to the gestures. The gesture mapping table may indicate a mapping relation between a gesture performed by the user wearing the wearable device 100 and an operation (or, a function) to be requested by the wearable device 100 for the electronic device 200 to perform in response to the gesture.

For example, according to a direction in which the wearable device 100 faces, the wearable device 100 may recognize a gesture performed by the user, and may change content of a control command to be transmitted to the electronic device 200 based on the gesture performed by the user being recognized. For example, according to a direction in which the wearable device 100 faces, the wearable device 100 may change a function of the electronic device 200 which corresponds to the gesture. For example, according to a direction in which the wearable device 100 faces, the wearable device 100 may change a function of the electronic device 200 which is to be commanded for the electronic device 200 to perform (or, control), in response to a gesture.

In an embodiment of the disclosure, the wearable device 100 may identify a direction in which the wearable device 100 faces (e.g., a direction in which the display of the wearable device 100 faces or a direction of a wrist of the user wearing the wearable device 100). The wearable device 100 may select a gesture mapping table to determine which gesture and function are to be connected according to the determined direction. For example, based on a direction in which the wearable device 100 faces, the wearable device 100 may determine a type of the gesture mapping table to be a first gesture mapping table 532. For example, based on a direction in which the wearable device 100 faces, the wearable device 100 may determine a type of the gesture mapping table to be a second gesture mapping table 534.

For example, when a direction in which the wearable device 100 faces is identified to be at least one of a second direction or a third direction, the wearable device 100 may determine a type of the gesture mapping table to be the first gesture mapping table 532. For example, when a direction in which the wearable device 100 faces is identified to be a first direction, the wearable device 100 may determine a type of the gesture mapping table to be the second gesture mapping table 534. In an embodiment of the disclosure, the wearable device 100 may store at least one gesture mapping table. The first gesture mapping table 532 and the second gesture mapping table 534 will be described in detail with reference to FIGS. 6A and 6B.

According to a direction of the display of the wearable device 100, a function to be performed in the electronic device 200 may vary even for the same gesture. For example, according to a direction in which the wearable device 100 faces, content of a control command to be transmitted to the electronic device 200 may vary in response to a gesture identified by the wearable device 100.

In an embodiment of the disclosure, when a direction in which the display of the wearable device 100 faces is identified to be at least one of a second direction or a third direction, the wearable device 100 may transmit a first control command to the electronic device 200 based on a first gesture being identified. For example, when the direction in which the display of the wearable device 100 faces is identified to be the second direction or the third direction, the wearable device 100 may transmit the first control command for requesting the electronic device 200 to perform a ‘selection’ function based on a pinch gesture being identified.

According to an embodiment of the disclosure, when a direction in which the display of the wearable device 100 faces is identified to be a first direction, the wearable device 100 may transmit a second control command to the electronic device 200 based on a first gesture being identified. For example, when the direction in which the display of the wearable device 100 faces is identified to be the first direction, the wearable device 100 may transmit, to the electronic device 200, the second control command for requesting to perform a ‘decreasing channel’ function based on a pinch gesture being identified.

In this manner, according to a direction in which the wearable device 100 faces, the wearable device 100 may vary a command to be transmitted to the electronic device 200 based on a gesture of the user wearing the wearable device 100, so that various functions of the electronic device 200 may be controlled by limited types of gesture. By doing so, the user of the wearable device 100 is able to control various functions of the electronic device 200 by only few gestures, so that a more intuitive user experience may be provided.

In an embodiment of the disclosure, the first direction, the second direction, or the third direction may indicate different directions or direction may indicate same direction. At least one of the first direction, the second direction, or the third direction may indicate a particular direction in which the wearable device 100 faces or may indicate a range of a direction in which the wearable device 100 faces. At least one of the first direction, the second direction, or the third direction may indicate a particular angle between the wearable device 100 and the ground or may indicate a range of an angle between the wearable device 100 and the ground.

For example, the first direction may indicate at least one of a direction in which the wearable device 100 faces the ground, a direction in which a front face of the display of the wearable device 100 faces the ground, or a direction in which the back of the hand of the user wearing the wearable device 100 faces the ground, but the disclosure is not limited to the described embodiment. For example, the second direction may indicate at least one of a direction in which the wearable device 100 faces the opposite to the ground (or, upward direction), a direction in which the front face of the display of the wearable device 100 faces the opposite to the ground (or, upward direction), or a direction in which the back of the hand of the user wearing the wearable device 100 faces the opposite to the ground (or, upward direction), but the disclosure is not limited to the described embodiment. For example, the third direction may indicate at least one of a direction in which the wearable device 100 faces the side, a direction in which the front face of the display of the wearable device 100 faces the side, or a direction in which the back of the hand of the user wearing the wearable device 100 faces the side, but the disclosure is not limited to the described embodiment.

FIGS. 6A and 6B are reference diagrams indicating gesture mapping tables, according to an embodiment of the disclosure.

As described with reference to FIG. 5B, the wearable device 100 may select a gesture mapping table, according to a direction in which the display of the wearable device 100 faces. According to a direction in which the display of the wearable device 100 faces, the wearable device 100 may select a gesture mapping table from among a plurality of gesture mapping tables stored in the wearable device 100. For example, when a direction in which the display of the wearable device 100 faces is identified to be a second direction or a third direction, the wearable device 100 may select a first gesture mapping table. For example, when a direction in which the display of the wearable device 100 faces is identified to be a first direction, the wearable device 100 may select a second gesture mapping table. Hereinafter, with reference to FIGS. 6A and 6B, the first gesture mapping table and the second gesture mapping table will now be described.

FIG. 6A is a reference diagram for describing the first gesture mapping table according to an embodiment of the disclosure.

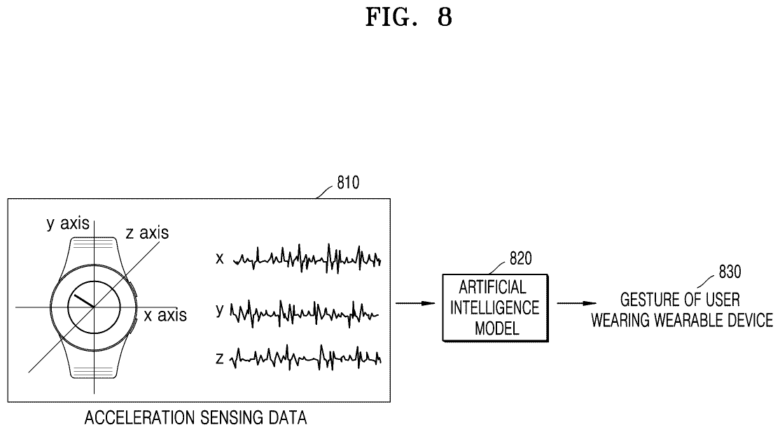

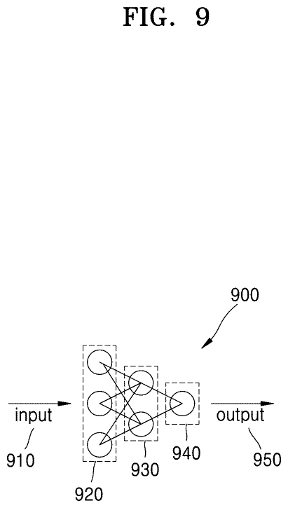

A first gesture mapping table 610 corresponds to an embodiment of the disclosure which indicates a mapping relation between gestures of a user who is wearing the wearable device 100 and functions of the electronic device 200. Referring to FIG. 6A, at least one gesture of the user wearing the wearable device 100 may respectively correspond to functions of the electronic device 200. According to an embodiment of the disclosure, the wearable device 100 may recognize (or, identify) a gesture of the user wearing the wearable device 100. The wearable device 100 may recognize a gesture of the user wearing the wearable device 100, by using an AI model, and this will be described in detail with reference to FIGS. 8 and 9.

When the wearable device 100 recognizes a gesture of the user wearing the wearable device 100, the wearable device 100 may transmit, to the electronic device 200, a command for requesting to perform an operation of the electronic device 200 which corresponds (or, is mapped) to the recognized gesture. When a direction in which the display of the wearable device 100 faces is identified to be a second direction or a third direction, the wearable device 100 may generate (or, obtain) a command for requesting to perform an operation of the electronic device 200 which corresponds (or, is mapped) to a gesture recognized by the wearable device 100, according to the first gesture mapping table 610. The wearable device 100 may transmit the generated (or obtained) command to the electronic device 200. The first gesture mapping table 610 may correspond to a table indicating a mapping relation between gestures and basic functions of the electronic device 200.

The electronic device 200 may obtain, from the wearable device 100, a command for requesting to perform an operation or a function. The electronic device 200 may perform the operation or the function included in the command. The electronic device 200 may transmit an indication that the operation or the function has been normally performed, to the electronic device 200. At least one of the wearable device 100 or the electronic device 200 may provide a feedback indicating that an operation corresponding to the gesture has been normally performed. For example, at least one of the wearable device 100 or the electronic device 200 may provide, via a display, a speech feedback, or a haptic feedback, a user with a notification indicating that an operation corresponding to the gesture has been normally performed.

However, gesture mapping between gestures and operations of the electronic device 200 are not limited to what are shown in FIGS. 6A and 6B, and in one or more embodiments of the disclosure, unlike to the first gesture mapping table 610, gestures of the user wearing the wearable device 100 may be mapped to operations (or, functions) of the electronic device 200.

In an embodiment of the disclosure, a pinch gesture 611 may indicate a motion of touching two fingers (e.g., thumb and index finger). For example, the pinch gesture 611 may indicate a motion of touching two fingers (e.g., thumb and index finger) one time. In an embodiment of the disclosure, a double pinch gesture 612 may indicate a motion of touching two fingers (e.g., thumb and index finger) two times. For example, a double pinch gesture may indicate a motion of touching two fingers (e.g., thumb and index finger), separating the touched two fingers, and then touching the two fingers again. In an embodiment of the disclosure, a fist gesture 613 may indicate a motion of clenching a fist. In an embodiment of the disclosure, a double fist gesture 614 may indicate a motion of clenching a fist two times. For example, the double fist gesture 614 may indicate a motion of clenching a fist one time, opening the clenched fist, and then clenching the fist again.

In an embodiment of the disclosure, a back-and-forth shaking gesture 615 may indicate a motion of moving a hand from a first position to a second position. For example, the back-and-forth shaking gesture 615 may indicate a motion in which the user moves a user's hand from a position (first position) close (or, proximate) to a user's body to a position (second position) distant from the user's body. For example, the back-and-forth shaking gesture 615 may indicate a motion in which the user moves a user's hand from a position (first position) distant from a user's body to a position (second position) close (or, proximate) to the user's body.

For example, the back-and-forth shaking gesture 615 may indicate a motion in which the user moves a user's hand from a level (e.g., eye level, chest level, etc.) close (or, proximate) to a user's body to a level (e.g., head level) distant from the user's body. For example, the back-and-forth shaking gesture 615 may indicate a motion in which the user moves a user's hand from a position (e.g., in front of chest or face) close (or, proximate) to a user's body to a position (e.g., a few centimeters forward, left, or right from the user's body) distant from the user's body.

In an embodiment of the disclosure, at least one of the pinch gesture 611, the double pinch gesture 612, the fist gesture 613, the double fist gesture 614, or the back-and-forth shaking gesture 615 may correspond to at least one operation (or, function) of the electronic device 200. When the wearable device 100 recognizes at least one gesture of the user wearing the wearable device 100, from among the pinch gesture 611, the double pinch gesture 612, the fist gesture 613, the double fist gesture 614, or the back-and-forth shaking gesture 615, the wearable device 100 may generate a command for requesting (or, controlling) to perform at least one operation (or, function) of the electronic device 200 which corresponds to each corresponding gesture, based on the first gesture mapping table 610. The wearable device 100 may transmit the generated command to the electronic device 200. Hereinafter, the first gesture mapping table 610 according to an embodiment of the disclosure will now be described.

According to an embodiment of the disclosure, the pinch gesture 611 may correspond to a selection operation (or, function) of the electronic device 200. The wearable device 100 may recognize the pinch gesture 611 of the user wearing the wearable device 100, based on sensing data obtained from at least one sensor. When the wearable device 100 recognizes the pinch gesture 611, the wearable device 100 may generate a command for requesting (or, controlling) to select a user interface element focused on a user interface output on the electronic device 200. When the wearable device 100 recognizes the pinch gesture 611, the wearable device 100 may transmit, to the electronic device 200, a command for requesting (or, controlling) to select a user interface element focused on the electronic device 200. When a direction in which the display of the wearable device 100 faces is a second direction or a third direction and the wearable device 100 recognizes the pinch gesture 611, the wearable device 100 may transmit, to the electronic device 200, a command for requesting (or, controlling) to select a user interface element focused on the electronic device 200.

The electronic device 200 may obtain, from the wearable device 100, the command for requesting (or, controlling) to select the focused user interface element. The electronic device 200 may perform an operation of selecting or executing the user interface element focused at a time point of receiving the command. The electronic device 200 may transmit an indication that the focused user interface element has been selected or executed, to the wearable device 100. At least one of the wearable device 100 or the electronic device 200 may provide a feedback indicating that the focused user interface element of the electronic device 200 has been normally selected or executed. For example, at least one of the wearable device 100 or the electronic device 200 may provide, via a display, a speech feedback, or a haptic feedback, the user with a notification indicating that the focused user interface element of the electronic device 200 has been selected or executed.

According to an embodiment of the disclosure, the fist gesture 613 may correspond to a cancellation operation (or, function) of the electronic device 200. When the wearable device 100 recognizes the fist gesture 613 of the user wearing the wearable device 100, the wearable device 100 may generate a command for requesting (or, controlling) to undo or stop a particular input or an executed task performed by a user of the electronic device 200. When the wearable device 100 recognizes the fist gesture 613, the wearable device 100 may transmit, to the electronic device 200, a command for requesting (or, controlling) to undo or stop the particular input or the executed task performed by the user of the electronic device 200. For example, a cancellation operation may include at least one of undoing or cancelling a task in a user interface of the electronic device 200, content playback stop, download stop, disconnection, execution cancellation, or return. When a direction in which the display of the wearable device 100 faces is a second direction or a third direction and the wearable device 100 identifies the fist gesture 613, the wearable device 100 may transmit, to the electronic device 200, a command for requesting (or, controlling) to perform a cancellation operation.

The electronic device 200 may obtain, from the wearable device 100, a command for requesting (or, controlling) to undo or stop a particular input or an executed task performed by the user of the electronic device 200. The electronic device 200 may undo or stop the particular input or the executed task performed by the user at a time point of receiving the command. The electronic device 200 may transmit an indication that the input or the task has been normally cancelled, to the wearable device 100. At least one of the wearable device 100 or the electronic device 200 may provide a feedback indicating that the particular input or the executed task performed in the electronic device 200 by the user has been normally undone or stopped. For example, at least one of the wearable device 100 or the electronic device 200 may provide, via a display, a speech feedback, or a haptic feedback, the user with a notification indicating that the particular input or the executed task performed by the user has been undone or stopped.

With the pinch gesture 611 and the fist gesture 613, the user wearing the wearable device 100 may manipulate the user interface of the electronic device 200 by an intuitive hand motion without pressing a physical button or directly touching a screen, so that a more convenient and intuitive user experience may be provided.

In an embodiment of the disclosure, the double fist gesture 614 may correspond to an operation (or, function) of returning to a home screen of the electronic device 200. When the wearable device 100 recognizes the double fist gesture 614 of the user wearing the wearable device 100, the wearable device 100 may generate a command for requesting (or, controlling) to return to a home screen of a user interface of the electronic device 200. When the wearable device 100 recognizes the double fist gesture 614, the wearable device 100 may transmit, to the electronic device 200, a command for requesting (or, controlling) to return to a home screen of a user interface of the electronic device 200. When the direction in which the display of the wearable device 100 faces is identified to be the second direction or the third direction, and the wearable device 100 identifies the double fist gesture 614, the wearable device 100 may transmit, to the electronic device 200, a command for requesting (or, controlling) to return to the home screen.

The electronic device 200 may receive, from the wearable device 100, a command for requesting (or, controlling) to return to a home screen of the user interface. At a time point of receiving the command, the electronic device 200 may perform an operation of returning to the home screen of the user interface. The electronic device 200 may transmit, to the wearable device 100, an indication that the electronic device 200 has normally returned to the home screen of the user interface. At least one of the wearable device 100 or the electronic device 200 may provide a feedback indicating that the electronic device 200 has normally returned to the home screen of the user interface. For example, at least one of the wearable device 100 or the electronic device 200 may provide, via a display, a speech feedback, or a haptic feedback, a user with a notification indicating that it has returned to the home screen of the user interface. With the double fist gesture 614, the user wearing the wearable device 100 is able to return to the home screen of the electronic device 200 by an intuitive hand motion, without pressing a physical button or directly touching the screen, so that it is possible to provide a more convenient and intuitive user experience.

In an embodiment of the disclosure, the back-and-forth shaking gesture 615 may correspond to a playback or pause operation (or, function) of the electronic device 200. When the wearable device 100 recognizes the back-and-forth gesture 615 of the user wearing the wearable device 100, the wearable device 100 may generate a command for requesting (or, controlling) to play back or pause content of the electronic device 200. Based on the wearable device 100 recognizes the back-and-forth gesture 615, the wearable device 100 may transmit, to the electronic device 200, the command for requesting (or, controlling) to play back or pause content of the electronic device 200. Based on the direction in which the display of the wearable device 100 faces is identified to be the second direction or the third direction, and the wearable device 100 recognizes the back-and-forth gesture 615, the wearable device 100 may transmit, to the electronic device 200, the command for requesting (or, controlling) the electronic device 200 to perform a playback or pause operation.

The electronic device 200 may receive, from the wearable device 100, the command for requesting (or, controlling) to play back or pause content. The electronic device 200 may pause content based on determining that the content is being played back at a time point of receiving the command. The electronic device 200 may play back content when it is determined that the content is paused at a time point of receiving the command. The electronic device 200 may play back content focused at a time point of receiving the command.

The electronic device 200 may transmit, to the wearable device 100, an indication that content has been normally played back or paused. At least one of the wearable device 100 or the electronic device 200 may provide a feedback indicating that content of the electronic device 200 has been normally played back or paused. For example, at least one of the wearable device 100 or the electronic device 200 may provide, via a display, a speech feedback, or a haptic feedback (e.g., vibration), a user with a notification indicating that content is played back or paused. With the back-and-forth gesture 615, the user wearing the wearable device 100 is able to control playback of the electronic device 200 by an intuitive hand motion, without pressing a physical button or directly touching the screen, so that it is possible to provide a more convenient and intuitive user experience.

FIG. 6B is a reference diagram for describing a second gesture mapping table according to an embodiment of the disclosure.

A second gesture mapping table 620 corresponds to an embodiment of the disclosure which indicates a mapping relation between a user wearing the wearable device 100 and the electronic device 200. Referring to FIG. 6B, at least one gesture of the user wearing the wearable device 100 may respectively correspond to operations of the electronic device 200. In an embodiment of the disclosure, the wearable device 100 may recognize a gesture of the user wearing the wearable device 100. The wearable device 100 may recognize a gesture of the user wearing the wearable device 100, by using an AI model, and this will be described in detail with reference to FIGS. 8 and 9.

When the wearable device 100 recognizes a gesture of the user wearing the wearable device 100, the wearable device 100 may transmit, to the electronic device 200, a command for requesting to perform an operation of the electronic device 200 which corresponds (or is mapped) to the recognized gesture. Based on a direction in which the display of the wearable device 100 faces is a first direction, the wearable device 100 may generate a command for requesting to perform an operation of the electronic device 200 which corresponds (or is mapped) to the recognized gesture, according to the second gesture mapping table 620. The wearable device 100 may transmit the generated command to the electronic device 200. The second gesture mapping table 620 may correspond to a table indicating a mapping relation between gestures and functions related to playback control of the electronic device 200.

The electronic device 200 may obtain, from the wearable device 100, a command for requesting to perform an operation or a function. The electronic device 200 may perform the operation or the function included in the command. The electronic device 200 may transmit, to the wearable device 100, an indication that the operation or the function has been normally performed. At least one of the wearable device 100 or the electronic device 200 may provide a feedback indicating that an operation corresponding to a gesture has been normally performed. For example, at least one of the wearable device 100 or the electronic device 200 may provide, via a display, a speech feedback, or a haptic feedback, a user with a notification indicating that the operation corresponding to the gesture has been normally performed.

However, gesture mapping between gestures and operations of the electronic device 200 are not limited to what are shown in FIGS. 6A and 6B, and in one or more embodiments of the disclosure, different from the second gesture mapping table 620, gestures of the user wearing the wearable device 100 may be mapped to operations (or, functions) of the electronic device 200. Description of each gesture which is redundant to FIG. 6A is not provided here.

In an embodiment of the disclosure, at least one of a pinch gesture 621, a double pinch gesture 622, a fist gesture 623, a double fist gesture 624, or a back-and-forth gesture 625 may correspond to at least one operation (or, function) of the electronic device 200. When the wearable device 100 recognizes at least one gesture of the user wearing the wearable device, from among the pinch gesture 621, the double pinch gesture 622, the fist gesture 623, the double fist gesture 624, or the back-and-forth shaking gesture 625, the wearable device 100 may generate a command for requesting (or, controlling) to perform at least one operation (or, function) of the electronic device 200 which corresponds to each corresponding gesture, based on the second gesture mapping table 620. The wearable device 100 may transmit the generated command to the electronic device 200. Hereinafter, the second gesture mapping table 620 according to an embodiment of the disclosure will now be described.

According to an embodiment of the disclosure, the pinch gesture 621 may correspond to a channel decreasing operation (or, function) of the electronic device 200. The wearable device 100 may recognize the pinch gesture 621 of the user wearing the wearable device 100, via at least one sensor (or, based on sensing data obtained from at least one sensor). Based on the wearable device 100 recognizing the pinch gesture 621, the wearable device 100 may generate a command for requesting (or, controlling) to decrease a channel of the electronic device 200. Based on the wearable device 100 recognizing the pinch gesture 621, the wearable device 100 may transmit, to the electronic device 200, the command for requesting (or, controlling) to decrease a channel of the electronic device 200. When the direction in which the display of the wearable device 100 faces is the first direction, and the wearable device 100 recognizes the pinch gesture 621, the wearable device 100 may transmit, to the electronic device 200, the command for requesting (or, controlling) to decrease a channel.

The electronic device 200 may obtain, from the wearable device 100, the command for requesting (or, controlling) to decrease a channel. The electronic device 200 may decrease a channel by one step, the channel being activated at a time point of receiving the command, or may perform an operation of changing a channel according to a user-set particular condition. The electronic device 200 may transmit, to the wearable device 100, that the channel has been normally changed (or decreased). At least one of the wearable device 100 or the electronic device 200 may provide a feedback indicating that the channel of the electronic device 200 has been normally changed (or decreased). For example, at least one of the wearable device 100 or the electronic device 200 may provide, via a display, a speech feedback, or a haptic feedback, a user with a notification indicating that the channel has been normally changed (or decreased).

In an embodiment of the disclosure, the double pinch gesture 622 may correspond to a channel increasing operation (or, function) of the electronic device 200. Based on the wearable device 100 recognizing the double pinch gesture 622 of the user wearing the wearable device 100, the wearable device 100 may generate a command for requesting (or, controlling) to increase a channel of the electronic device 200. Based on the wearable device 100 recognizing the double pinch gesture 622, the wearable device 100 may generate a command for requesting (or, controlling) to increase a channel of the electronic device 200. Based on the direction in which the display of the wearable device 100 faces being the first direction, and the wearable device 100 identifies the double pinch gesture 622, the wearable device 100 may transmit, to the electronic device 200, the command for requesting (or, controlling) to increase a channel.

The electronic device 200 may obtain, from the wearable device 100, the command for requesting (or, controlling) to increase a channel. The electronic device 200 may increase a channel by one step, the channel being activated at a time point of receiving the command, or may perform an operation of changing a channel according to a user-set particular condition. The electronic device 200 may transmit, to the wearable device 100, that the channel has been normally changed (or increased). At least one of the wearable device 100 or the electronic device 200 may provide a feedback indicating that the channel of the electronic device 200 has been normally changed (or increased). For example, at least one of the wearable device 100 or the electronic device 200 may provide, via a display, a speech feedback, or a haptic feedback, a user with a notification indicating that the channel has been normally changed (or increased).

With the pinch gesture 621 and the double pinch gesture 622, the user wearing the wearable device 100 may change a channel of the electronic device 200 by an intuitive hand motion without pressing a physical button or directly touching a screen, so that a more convenient and intuitive user experience may be provided.

In an embodiment of the disclosure, the fist gesture 623 may correspond to a volume lowering operation (or, function) of the electronic device 200. Based on the wearable device 100 recognizing the fist gesture 623 of the user wearing the wearable device 100, the wearable device 100 may generate a command for requesting (or, controlling) to lower a volume of the electronic device 200. Based on the wearable device 100 recognizing the fist gesture 623, the wearable device 100 may transmit, to the electronic device 200, the command for requesting (or, controlling) to lower a volume of the electronic device 200. Based on the direction in which the display of the wearable device 100 faces being the first direction, and the wearable device 100 identifies the fist gesture 623, the wearable device 100 may transmit, to the electronic device 200, the command for requesting (or, controlling) to lower a volume.

The electronic device 200 may obtain, from the wearable device 100, command for requesting (or, controlling) to lower a volume. The electronic device 200 may lower a volume by one step, the volume being set at a time point of receiving the command, or may perform an operation of changing a volume according to a user-set particular condition. The electronic device 200 may transmit, to the wearable device 100, that the volume has been normally changed (or lowered). At least one of the wearable device 100 or the electronic device 200 may provide a feedback indicating that the volume of the electronic device 200 has been normally changed (or lowered). For example, at least one of the wearable device 100 or the electronic device 200 may provide, via a display, a speech feedback, or a haptic feedback, a user with a notification indicating that the volume has been normally changed (or lowered).

In an embodiment of the disclosure, the double fist gesture 624 may correspond to a volume raising operation (or, function) of the electronic device 200. Based on the wearable device 100 recognizing the double fist gesture 624 of the user wearing the wearable device 100, the wearable device 100 may generate a command for requesting (or, controlling) to raise a volume of the electronic device 200. Based on the wearable device 100 recognizing the double fist gesture 624, the wearable device 100 may transmit, to the electronic device 200, the command for requesting (or, controlling) to raise a volume of the electronic device 200. Based on the direction in which the display of the wearable device 100 faces being the first direction, and the wearable device 100 identifying the double fist gesture 624, the wearable device 100 may transmit, to the electronic device 200, the command for requesting (or, controlling) to raise a volume.

The electronic device 200 may obtain, from the wearable device 100, command for requesting (or, controlling) to raise a volume. The electronic device 200 may raise a volume by one step, the volume being set at a time point of receiving the command, or may perform an operation of changing a volume according to a user-set particular condition. The electronic device 200 may transmit, to the wearable device 100, that the volume has been normally changed (or increased). At least one of the wearable device 100 or the electronic device 200 may provide a feedback indicating that the volume of the electronic device 200 has been normally changed (or raised). For example, at least one of the wearable device 100 or the electronic device 200 may provide, via a display, a speech feedback, or a haptic feedback, a user with a notification indicating that the volume has been normally changed (or raised). With the fist gesture 623 and the double fist gesture 624, the user wearing the wearable device 100 may change a volume of the electronic device 200 by an intuitive hand motion without pressing a physical button or directly touching a screen, so that a more convenient and intuitive user experience may be provided.

In an embodiment of the disclosure, the back-and-forth shaking gesture 625 may correspond to a volume muting operation (or, function) of the electronic device 200. Based on the wearable device 100 recognizing the back-and-forth gesture 625 of the user wearing the wearable device 100, the wearable device 100 may generate a command for requesting (or, controlling) to mute a volume of the electronic device 200. Based on the wearable device 100 recognizing the back-and-forth gesture 625, the wearable device 100 may transmit, to the electronic device 200, the command for requesting (or, controlling) to mute a volume of the electronic device 200. Based on the direction in which the display of the wearable device 100 faces being the first direction, and the wearable device 100 identifying the back-and-forth gesture 625, the wearable device 100 may transmit, to the electronic device 200, the command for requesting (or, controlling) to mute a volume.

The electronic device 200 may obtain, from the wearable device 100, command for requesting (or, controlling) to mute a volume. The electronic device 200 may perform an operation of muting a volume set at a time point of receiving the command. The electronic device 200 may transmit, to the wearable device 100, an indication that the volume has been normally muted. At least one of the wearable device 100 or the electronic device 200 may provide a feedback indicating that the volume of the electronic device 200 has been normally muted. For example, at least one of the wearable device 100 or the electronic device 200 may provide, via a display, a speech feedback, or a haptic feedback (e.g., vibration), a user with a notification indicating that the volume has been normally muted. With the back-and-forth gesture 625, the user wearing the wearable device 100 may change a volume of the electronic device 200 by an intuitive hand motion without pressing a physical button or directly touching a screen, so that a more convenient and intuitive user experience may be provided.

FIGS. 6C and 6D are reference diagrams for describing a user guide that corresponds to a gesture mapping table output on the wearable device 100, according to an embodiment of the disclosure.

According to an embodiment of the disclosure, the wearable device 100 may output, to a display (or, a display area of the display), a user guide corresponding to a gesture mapping table. For example, the wearable device 100 may output, to a display (or, a display area of the display), a user guide 632 or 634 which corresponds to a first gesture mapping table. For example, the wearable device 100 may output, to a display (or, a display area of the display), a user guide 642 or 644 which corresponds to a second gesture mapping table. Although FIGS. 6C and 6D illustrate user guides being displayed on the wearable device 100, the embodiments are not limited to this configuration. For example, the user guide may be output as audio.

In an embodiment of the disclosure, based on a direction in which the display of the wearable device 100 faces being identified to be a second direction or a third direction, the wearable device 100 may output, to a display (or, a display area of the display), the user guide 632 or 634 which corresponds to the first gesture mapping table. The user guide 632 or 634 which corresponds to the first gesture mapping table may include gestures and functions of the electronic device 200 which correspond to the gestures and are included in the first gesture mapping table 610. The gesture may be shown as a drawing or a picture of a hand shape or may be indicated as a title of the gesture. For example, the user guide 632 or 634 which corresponds to the first gesture mapping table may include at least one of a pinch gesture and selection that is an operation of the electronic device 200 which corresponds to the pinch gesture, a fist gesture and cancellation that is an operation of the electronic device 200 which corresponds to the fist gesture, a double fist gesture and returning to home screen that is an operation of the electronic device 200 which corresponds to the double fist gesture, or a back-and-forth shaking gesture and playback/pause that is an operation of the electronic device 200 which corresponds to the back-and-forth shaking gesture. However, the disclosure is not limited to the described embodiment, and the user guide 632 or 634 which corresponds to the first gesture mapping table may include at least one of a pinch gesture and a first function that is an operation of the electronic device 200 which corresponds to the pinch gesture, a fist gesture and a second function that is an operation of the electronic device 200 which corresponds to the fist gesture, a double fist gesture and a third function that is an operation of the electronic device 200 which corresponds to the double fist gesture, or a back-and-forth shaking gesture and a fourth function that is an operation of the electronic device 200 which corresponds to the back-and-forth shaking gesture.

In an embodiment of the disclosure, based on the direction in which the display of the wearable device 100 faces being identified to be the first direction, the wearable device 100 may output, to a display (or, a display area of the display), the user guide 642 or 644 which corresponds to the second gesture mapping table. The user guide 642 or 644 which corresponds to the second gesture mapping table 620 may include gestures and functions of the electronic device 200 which correspond to the gestures and are included in the second gesture mapping table 620. The gesture may be shown as a drawing or a picture of a hand shape or may be indicated as a title of the gesture.

For example, the user guide 642 or 644 which corresponds to the second gesture mapping table may include at least one of a pinch gesture and a channel decrease that is an operation of the electronic device 200 which corresponds to the pinch gesture, a double pinch gesture and a channel increase that is an operation of the electronic device 200 which corresponds to the double pinch gesture, a fist gesture and volume lowering that is an operation of the electronic device 200 which corresponds to the fist gesture, a double fist gesture and volume raise that is an operation of the electronic device 200 which corresponds to the double fist gesture, or a back-and-forth shaking gesture and muting that is an operation of the electronic device 200 which corresponds to the back-and-forth shaking gesture. However, the disclosure is not limited to the described embodiment, and the user guide 642 or 644 which corresponds to the second gesture mapping table may include at least one of a pinch gesture and a fifth function that is an operation of the electronic device 200 which corresponds to the pinch gesture, a double pinch gesture and a sixth function that is an operation of the electronic device 200 which corresponds to the double pinch gesture, a fist gesture and a seventh function that is an operation of the electronic device 200 which corresponds to the fist gesture, a double fist gesture and an eighth function that is an operation of the electronic device 200 which corresponds to the double fist gesture, or a back-and-forth shaking gesture and a ninth function that is an operation of the electronic device 200 which corresponds to the back-and-forth shaking gesture.

In an embodiment of the disclosure, as the wearable device 100 outputs the user guide 632, 634, 642, or 644 which corresponds to a gesture mapping table to the display of the wearable device 100 according to a direction in which the display of the wearable device 100 faces, when a user performs a gesture, the user may intuitively recognize which function is to be performed in the electronic device 200. Therefore, the user may intuitively recognize which gesture is to be performed to perform a function of the electronic device 200. The user may control a function of the electronic device 200 by performing a gesture for executing a desired function of the electronic device 200, based on the user guide 632, 634, 642, or 644 which corresponds to a gesture mapping table, so that a user experience may be improved.

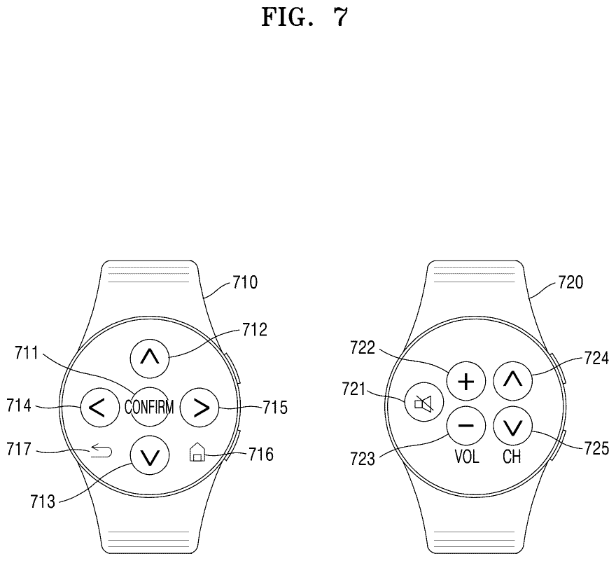

FIG. 7 is a reference diagram for describing a user interface that corresponds to each gesture mapping, according to an embodiment of the disclosure.

Referring to FIG. 7, the wearable device 100 may output, to the display 140, a user interface corresponding to a type of gesture mapping. For example, based on a type of gesture mapping being determined to be basic gesture mapping, the wearable device 100 may output, to the display 140, a user interface 710 corresponding to the basic gesture mapping. In one or more examples, based on a type of gesture mapping being determined to be playback control gesture mapping, the wearable device 100 may output, to the display 140, a user interface 720 corresponding to the playback control gesture mapping. In the descriptions below, the user interface 710 corresponding to the basic gesture mapping may be referred to as the first user interface 710, and the user interface 720 corresponding to the playback control gesture mapping is referred to as the second user interface 720.

According to an embodiment of the disclosure, the first user interface 710 may include at least one manipulation interface (e.g., a touch button, an icon, a slider, etc.), or the like for control of the electronic device 200. The first user interface 710 may include at least one manipulation interface (e.g., a touch button, an icon, a slider, etc.) corresponding to an operation of the electronic device 200 which is included in the basic gesture mapping. For example, the first user interface 710 may include at least one of a confirm icon 711, an upward icon 712, a downward icon 713, a leftward icon 714, a rightward icon 715, a return to home screen icon 716 or a backward icon 717. The confirm icon 711 may be substituted with a selection icon. The backward icon 717 may be substituted with a cancellation icon.

In an embodiment of the disclosure, the second user interface 720 may include at least one manipulation interface (e.g., a touch button, an icon, a slider, etc.) for control of the electronic device 200. The second user interface 720 may include at least one manipulation interface (e.g., a touch button, an icon, a slider, etc.) corresponding to an operation of the electronic device 200 which is included in the playback control gesture mapping. For example, the second user interface 720 may include at least one of a mute icon 721, a volume up icon 722, a volume down icon 723, a channel up icon 724, or a channel down icon 725.

In an embodiment of the disclosure, the wearable device 100 may output, to the display 140, a user interface corresponding to a type of gesture mapping, so that, when a user wearing the wearable device 100 performs a gesture, the user may pre-check an operation or a function to be executed in the electronic device 200. By doing so, the wearable device 100 may derive a user-expected operation to be correctly performed so that user convenience may be improved. The user interface shown in FIG. 7 is an example embodiment of the disclosure, and as understood by one of ordinary skill in the art, the disclosure is not limited to what is shown and described with reference to FIG. 7.

FIG. 8 is a reference diagram for describing a method by which an AI model recognizes a gesture, according to an embodiment of the disclosure.

According to an embodiment of the disclosure, the wearable device 100 may include an acceleration sensor. The wearable device 100 may obtain acceleration sensing data 810 by using the acceleration sensor. The wearable device 100 may pre-process the acceleration sensing data 810. Based on the acceleration sensing data 810 (or, pre-processed acceleration sensing data), the wearable device 100 may recognize a gesture 830 of a user who is wearing the wearable device 100.

According to an embodiment of the disclosure, the wearable device 100 may obtain the acceleration sensing data 810 by using the acceleration sensor. The wearable device 100 may obtain (or, measure) acceleration of at least one of X axis, Y axis, or Z axis, by using the acceleration sensor. For example, at least one of X axis, Y axis, or Z axis may be defined based on a state in which the user is wearing the wearable device 100. For example, when the user is wearing the wearable device 100 on a user's wrist, X axis may indicate a direction (horizontal direction) in which the wrist is horizontally moving, Y axis may indicate a direction in which the wrist is moving back and forth, and Z axis may indicate a direction (vertical direction) in which the wrist is vertically moving, but the disclosure is not limited to the described embodiment.

According to an embodiment of the disclosure, the wearable device 100 may sequentially obtain the acceleration sensing data 810 of at least one of X axis, Y axis, or Z axis, by using the acceleration sensor. The wearable device 100 may obtain the acceleration sensing data 810 by using the acceleration sensor at regular sampling intervals (e.g., 100 Hz, 200 Hz, etc.). Acceleration sensing data may be stored as sequential values over time.

According to an embodiment of the disclosure, X-axis acceleration sensing data may correspond to data indicating a variation in acceleration in a horizontal direction. Y-axis acceleration sensing data may correspond to data indicating a variation in acceleration in a back-and-forth direction. Z-axis acceleration sensing data may correspond to data indicating a variation in acceleration in a vertical direction. The Z-axis acceleration sensing data may include a gravitational effect.

In an embodiment of the disclosure, the wearable device 100 may pre-process the acceleration sensing data 810. In an embodiment of the disclosure, the wearable device 100 may pre-process acceleration sensing data by using an AI model 820. The wearable device 100 may pre-process acceleration sensing data by using an element (e.g., a processor and a memory) which are separate from the AI model 820. The wearable device 100 may remove noise included in the acceleration sensing data 810, and thus, may remove, from the acceleration sensing data 810, an affect due to hand shaking or motion of the wearable device 100. For example, the wearable device 100 may remove noise included in the acceleration sensing data 810 by using at least one of a low-frequency filter, a moving average filter, or a high-frequency filter. For example, the wearable device 100 may normalize the acceleration sensing data 810. The wearable device 100 may normalize the acceleration sensing data 810, and thus, may remove variation between a plurality of pieces of acceleration sensing data 810, the difference occurring due to a strength of a motion or a level of force of each user. In an embodiment of the disclosure, an operation in which the wearable device 100 pre-processes the acceleration sensing data 810 may be skipped.

In an embodiment of the disclosure, the wearable device 100 may identify the gesture 830 of the user wearing the wearable device 100, based on the acceleration sensing data 810 by using the AI model 820. The wearable device 100 may input the acceleration sensing data 810 to the AI model 820, and thus, may identify the gesture 830 of the user wearing the wearable device 100. For example, the AI model 820 may identify the gesture 830 of the user wearing the wearable device 100, by identifying at least one of a frequency pattern of acceleration sensing data or a level of acceleration for each axis (e.g., X axis, Y axis, or Z axis) included in the acceleration sensing data.

In one or more examples, the AI model 820 may be pre-trained to identify the gesture 830 of the user wearing the wearable device 100 based on the acceleration sensing data 810 obtained by using the acceleration sensor. A training process of the AI model 820 will be described in detail with reference to FIG. 9.

In an embodiment of the disclosure, the wearable device 100 may identify various gestures of the user wearing the wearable device 100. For example, the wearable device 100 may identify at least one gesture of the user wearing the wearable device 100, from among a pinch gesture, a double pinch gesture, a fist gesture, a double fist gesture, or a back-and-forth gesture, but the disclosure is not limited to the described embodiment.

FIG. 9 is a reference diagram for describing a method by which an AI model is trained with respect to gestures, according to an embodiment of the disclosure.

In one or more examples the operation being performed by the wearable device 100 may be identified by using an AI technology performing a computation using a neural network or a machine learning (ML) technology. The AI technology may identify at least one of i) an operation to be performed by an electronic device by identifying a gesture of a user wearing the wearable device 100 or ii) a trigger gesture performed by the user wearing the wearable device 100 to active a remote control function of the electronic device 200,

The AI technology refers to a technology for obtaining an intended result by performing processing such as analysis and/or classification with respect to input data, by performing computations via a neural network. The ML technology is a type of the AI technology that analyzes and/or classifies input data to autonomously discover patterns, and subsequently predicts or classifies new data, based on the previously learned patterns. The AI technology and the ML technology may be implemented by using an algorithm.

In this regard, the algorithm or a set of algorithms for implementing the AI technology and the ML technology may be referred to as a neural network. Here, the neural network may receive an input of input data, may perform computations for analysis and/or classification, and then may output resulting data. Here, the neural network may receive an input of input data, may perform computations for analysis and/or classification, and then may output resulting data. Here, ‘training’ may refer to training a neural network such that various pieces of data are input to the neural network and the neural network may be trained to discover or learn on its own a method of analyzing various pieces of data input to the neural network, a method of classifying the input pieces of data, and/or a method of extracting, from the input pieces of data, features necessary for generating resulting data. In detail, through a training process, the neural network may be trained based on training data (e.g., a plurality of different images) so as to optimize and set weight values in the neural network. Then, the neural network having the optimized weight values may output an intended result by learning input data by itself.

In one or more examples, the neural network that includes a plurality of hidden layers for performing computations, that is, the depth of which for performing computations is high, may be classified as a deep neural network. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), and a Deep Q-Networks, but the disclosure is not limited thereto. In addition, the neural network may be subdivided. For example, the CNN may be subdivided into a deep CNN (DCNN), a capsule neural network (CapsNet) (not shown), and the like.

In an embodiment of the disclosure, the ‘AI model’ may refer to a neural network including at least one layer operating to receive input data and output an intended result. Also, the ‘AI model’ may refer to an algorithm for outputting an intended result by performing computations via a neural network, a set of a plurality of algorithms, a processor for executing the algorithm or the set of algorithms, software for executing the algorithm or the set of algorithms, or hardware for executing the algorithm or the set of algorithms.

Referring to FIG. 9, a neural network 900 may be trained by receiving an input of training data. Then, the trained neural network 900 may receive input data 910 via an input end 920, and the input end 920, a hidden layer 930, and an output end 940 may perform computations for analyzing the input data 910 and outputting output data 950 that is an intended result. Computations in the neural network may be performed via the hidden layer 930. For convenience, FIG. 9 illustrates the hidden layer 930 that is simply shown as one layer, but the hidden layer 930 may include a plurality of layers.

In detail, in an embodiment of the disclosure, the neural network 900 may be trained to obtain a gesture of a user wearing the wearable device 100, from acceleration sensing data. In an embodiment of the disclosure, the neural network 900 may be trained to obtain a trigger gesture of the user wearing the wearable device 100, from the acceleration sensing data.

In an embodiment of the disclosure, the neural network 900 that performs at least one of i) operation of identifying a gesture of the user wearing the wearable device 100 or ii) operation of recognizing the trigger gesture of the user wearing the wearable device 100 may be implemented in at least one of the processor 130 or the memory 120 of the wearable device 100. The processor 130 may include an AI-dedicated processor such as a neural processing unit (NPU),

FIG. 10 is a reference diagram for describing a method of controlling a pointer output on the electronic device 200, based on movement of the wearable device 100, according to an embodiment of the disclosure.

In an embodiment of the disclosure, the wearable device 100 may control a pointer output on the display (or, a display screen) of the electronic device 200, based on movement of the wearable device 100. In an embodiment of the disclosure, the pointer may indicate (e.g., highlight or enlarge) an interface element output on the display (or, the display screen) of the electronic device 200 so as to point or manipulate a particular position according to a user input. For example, the pointer may facilitate user interaction between a display of an electronic device and a user, and may be implemented as various forms. In one or more examples, the pointer may be displayed in the form of a cursor that is a blinking symbol indicating a user input position in a text input area, or in the form of an arrow that is a symbol pointing to a particular point on a screen such as a general mouse pointer. In one or more examples, the pointer may be represented as a circle, a cross hair, a hand shape, or the like. In one or more examples, when the point is near or hovers around an interface element (e.g., button of menu displayed on electronic device), the interface element may be highlighted, change color, change size, etc.

In an embodiment of the disclosure, the wearable device 100 may control the pointer output on the display (or, the display screen) of the electronic device 200, based on a direction in which the wearable device 100 is moved. In an embodiment of the disclosure, the wearable device 100 may transmit, to the electronic device 200, a command for requesting to change a position of the pointer output on the display (or, the display screen) of the electronic device 200, based on a direction in which the wearable device 100 is moved.

In an embodiment of the disclosure, based on the wearable device 100 identifying that the wearable device 100 is moved in a left direction (1010), the wearable device 100 may transmit, to the electronic device 200, a command for requesting to move, in the left direction (1020), the pointer output on the display of the electronic device 200. For example, based on the wearable device 100 identifies that the wearable device 100 is moved in a right direction (1012), the wearable device 100 may transmit, to the electronic device 200, a command for requesting to move, in the right direction (1022), the pointer output on the display of the electronic device 200.

For example, based on the wearable device 100 identifying that the wearable device 100 is moved in an upward direction, the wearable device 100 may transmit, to the electronic device 200, a command for requesting to move, in the upward direction, the pointer output on the display of the electronic device 200. For example, based on the wearable device 100 identifying that the wearable device 100 is moved in a downward direction, the wearable device 100 may transmit, to the electronic device 200, a command for requesting to move, in the downward direction, the pointer output on the display of the electronic device 200.

In an embodiment of the disclosure, when a motion degree (or level) of the wearable device 100 increases, the wearable device 100 may transmit, to the electronic device 200, a command for requesting to further move the pointer output on the display of the electronic device 200. In an embodiment of the disclosure, when a motion speed of the wearable device 100 increases, the wearable device 100 may transmit, to the electronic device 200, a command for requesting to further rapidly move the pointer output on the display of the electronic device 200. A user may intuitively control the electronic device 200 by using the wearable device 100 as a cursor or a mouse so that a user experience may be improved.

However, the embodiments of the disclosure are not limited to these configurations. For example, according to the wearable device 100, the electronic device 200, an application or user setting, a position of a pointer output on the display of the electronic device 200 may be changed in a direction different from a direction in which the wearable device 100 is moved. For example, when the wearable device 100 identifies that the wearable device 100 is moved in an upward direction, the wearable device 100 may transmit, to the electronic device 200, a command for requesting to move, in the upward direction, the pointer output on the display of the electronic device 200.

FIG. 11 is a reference diagram for describing a method of moving a focus of the electronic device 200, based on movement of the wearable device 100, according to an embodiment of the disclosure.

Referring to FIG. 11, an operating method of the wearable device 100 or the electronic device 200 may include operation 1110 to operation 1190. In an embodiment of the disclosure, operation 1110 to operation 1190 may be performed by at least one processor included in the wearable device 100 or the electronic device 200. The operating method of the wearable device 100 or the electronic device 200 is not limited to the operations shown in FIG. 11, and in one or more embodiments of the disclosure, the operating method may further include operations not shown in FIG. 11 or some operations may be skipped.

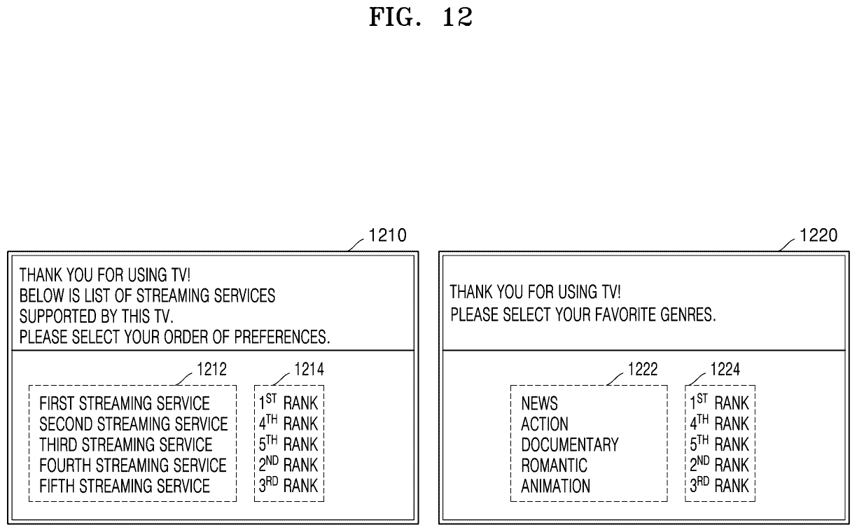

Referring to operation 1110, the electronic device 200 may obtain a user's preference in an initial setting. Operation 1110 will be described in detail with reference to FIG. 12.

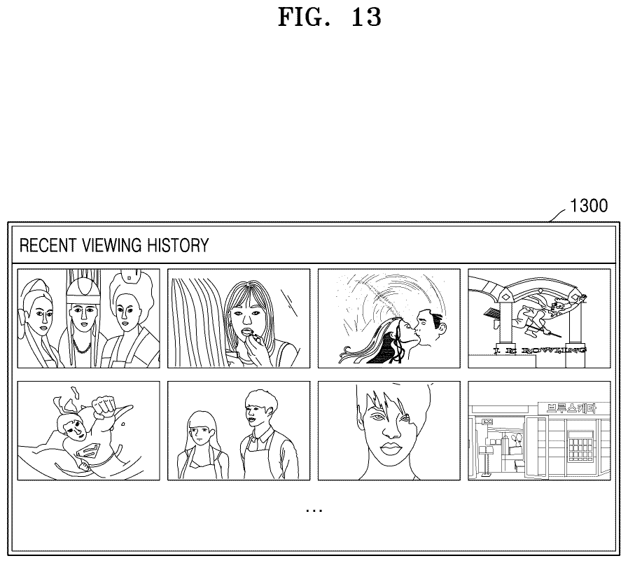

Referring to operation 1120, the electronic device 200 may obtain a user's usage history (e.g., viewing history) with respect to the electronic device 200. Operation 1120 will be described in detail with reference to FIG. 13.

Referring to operation 1130, the wearable device 100 may identify a direction of the wearable device 100. For example, the wearable device 100 may identify a direction in which the wearable device 100 faces as a second direction. An embodiment of the disclosure in which the wearable device 100 identifies a direction in which the wearable device 100 faces is described with reference to FIG. 5, and thus, descriptions thereof are not provided here.

Referring to operation 1140, when the wearable device 100 identifies the direction in which the wearable device 100 faces a second direction, the wearable device 100 may determine to change a focus output on the display of the electronic device 200, based on a direction in which the wearable device 100 is moved. When the wearable device 100 identifies the direction in which the wearable device 100 faces as the second direction, the wearable device 100 may determine to request the electronic device 200 to change the focus output on the display of the electronic device 200, based on the direction in which the wearable device 100 is moved. Operation 1140 is described with reference to FIG. 4, and thus, descriptions thereof are not provided here.

Referring to operation 1150, the wearable device 100 may transmit, to the electronic device 200, an indication that it is determined to change the focus output on the display of the electronic device 200, based on the direction in which the wearable device 100 is moved. The wearable device 100 may transmit, via a communication interface to the electronic device 200, an indication that it is determined to change the focus output on the display of the electronic device 200, based on the direction in which the wearable device 100 is moved. The wearable device 100 may transmit, to the electronic device 200 by using a Bluetooth communication module included in the communication interface, an indication that it is determined to change the focus output on the display of the electronic device 200, based on the direction in which the wearable device 100 is moved.

Referring to operation 1160, the electronic device 200 may obtain focus priority orders of a plurality of pieces of content output on the electronic device 200, based on at least one of a user's preference or a user's usage history.

In an embodiment of the disclosure, a focus may indicate a state in which one or more elements (e.g., content, a user interface element, etc.) of the display of the electronic device 200 are selected or highlighted. The focus may indicate a state in which the one or more elements of the display of the electronic device 200 are activated.

In an embodiment of the disclosure, a focus priority order may indicate a reference of determining where the focus is to be preferentially set by the electronic device 200 from among the one or more elements (e.g., content, a user interface element, etc.). The focus priority order may indicate a priority order by which the electronic device 200 determines the focus. For example, the electronic device 200 may set the focus on content with the highest focus priority order.

In an embodiment of the disclosure, the plurality of pieces of content may correspond to various types of media and information elements that may be provided to a user via the electronic device 200. For example, the plurality of pieces of content may include at least one of video content, audio content, interactive content, text and graphic based content, or real-time streaming content. The video content may include at least one of a drama, a movie, a documentary, a TV program, a sports event, or animation. The audio content may include at least one of music, pod cast, news radio, or an audio book. The interactive content may include at least one of a game, virtual reality (VR) content, or augmented reality (AR) content. The text and graphic based content may include at least one of news, an electronic book, website content, or a digital magazine. The real-time streaming content may include at least one of live broadcasting, a real-time meeting, sports broadcasting, or game streaming.

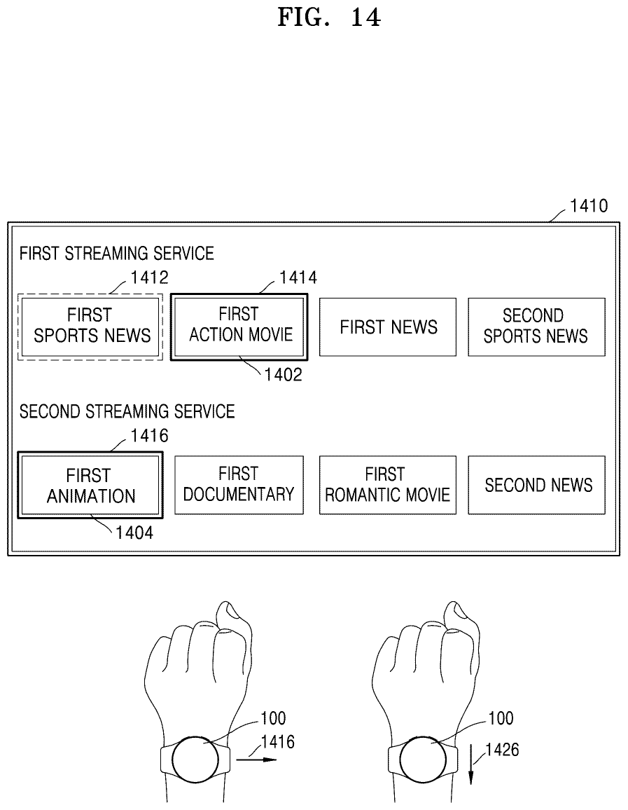

Operation 1160 will be described in detail with reference to FIG. 14.

Referring to operation 1170, the electronic device 200 may identify whether the focus priorities of the plurality of pieces of content are the same. For example, the electronic device 200 may identify whether there are two or more pieces of content that correspond to a highest priority. For example, the electronic device 200 may identify whether a focus of the electronic device 200 is determined, based on the focus priority order determined in operation 1160. In one or more examples, the electronic device 200 may identify whether the focus is determined based on the focus priority order determined based on at least one of the user's preference or the user's usage history.

In an embodiment of the disclosure, when the focus priority orders of the plurality of pieces of content are equal (e.g., when there are two or more pieces of content that correspond to a highest priority order), operation 1180 may be performed. When the focus priority orders of the plurality of pieces of content are not equal (e.g., when there is one content that corresponds to a highest priority order), the electronic device 200 may perform operation 1190.

Referring to operation 1180, the electronic device 200 may obtain a motion (or, a motion direction) of the wearable device 100. The wearable device 100 may transmit the motion (or, the motion direction) of the wearable device 100 to the electronic device 200. For example, the wearable device 100 may transmit, to the electronic device 200, the motion of the wearable device 100 which is identified by using at least one of the acceleration sensor or the gyroscope sensor. For example, the wearable device 100 may transmit, to the electronic device 200, at least one of a direction or an angle in which the wearable device 100 is moved. The electronic device 200 may obtain, from the wearable device 100, at least one of the direction or the angle in which the wearable device 100 is moved. In one or more examples, before operation 1180 is performed, the electronic device 200 may transmit a request to the wearable device 100 to provide motion of the wearable device based on determining in operation 1170 that the focus priorities of the plurality of pieces of content are the same.

Referring to operation 1190, the electronic device 200 may set a focus on a display of the electronic device 200. When the focus priority orders of the plurality of pieces of content are not equal (NO in operation 1170), the electronic device 200 may set the focus, based on the focus priority orders obtained based on the user's preference and the user's usage history. For example, the electronic device 200 may set the focus on content with the highest focus priority order obtained based on the user's preference and the user's usage history.

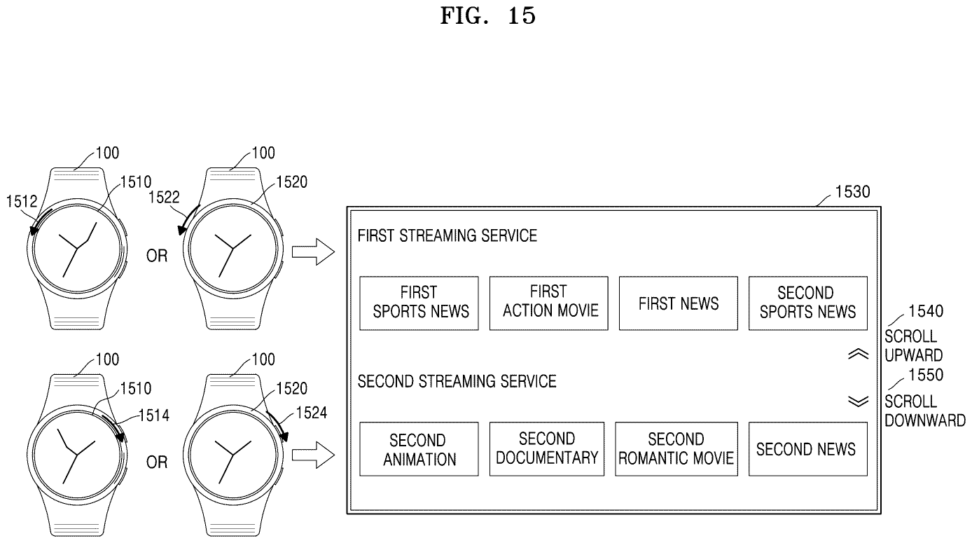

When it is determined that the focus priority orders of the plurality of pieces of content are equal (YES in operation 1170), the electronic device 200 may set the focus, based on a motion of the wearable device 100 which is obtained from the wearable device 100 in operation 1180. Operation 1190 will be described in detail with reference to FIGS. 14 and 15.

FIG. 12 is a reference diagram for describing a method by which the electronic device 200 obtains a user's preference, according to an embodiment of the disclosure.

According to an embodiment of the disclosure, the electronic device 200 may obtain a user's preference (e.g., first example embodiment 1210). The electronic device 200 may obtain a user's preference 1214 for a plurality of streaming services 1212. For example, the electronic device 200 may obtain at least one of a preference order, a preference value, or preference or non-preference for the plurality of streaming services 1212. For example, the electronic device 200 may obtain a user's preference for the plurality of streaming services 1212 via an input/output interface (e.g., a touch screen, a keyboard, a mouse, or a microphone). For example, the electronic device 200 may obtain the user's preference 1214 for the plurality of streaming services 1212 from a remote control device via the communication interface. For example, the electronic device 200 may obtain a user input of inputting the preference 1214 for the plurality of streaming services 1212. For example, the electronic device 200 may obtain the user's preference 1214 for the plurality of streaming services 1212 from an external electronic device or a server via the communication interface. For example, the electronic device 200 may obtain the user's preference 1214 for the plurality of streaming services 1212 that are interconnected with a user account.

According to an embodiment of the disclosure, the plurality of streaming services 1212 may include a plurality of applications provided by the electronic device 200. For example, the plurality of streaming services 1212 may include at least one of a music streaming service, a video streaming service, a pod cast service, or a game streaming service, but the disclosure is not limited to the described embodiment.

According to an example second embodiment 1220, the electronic device 200 may obtain a user's preference 1224 for a plurality of content genres 1222. For example, the electronic device 200 may obtain at least one of a preference order or a preference value for the plurality of content genres 1222. For example, the electronic device 200 may obtain the user's preference 1224 for the plurality of content genres 1222 via an input/output interface (e.g., a touch screen, a keyboard, a mouse, or a microphone). For example, the electronic device 200 may obtain the user's preference 1224 for the plurality of content genres 1222 from a remote control device via the communication interface. For example, the electronic device 200 may obtain a user input of inputting the user's preference 1224 for the plurality of content genres 1222. For example, the electronic device 200 may obtain the user's preference 1224 for the plurality of content genres 1222 from an external electronic device or a server via the communication interface. For example, the electronic device 200 may obtain the user's preference 1224 for the plurality of content genres 1222 that are interconnected with a user account.

According to an embodiment of the disclosure, the plurality of content genres 1222 may include at least one of a news genre, an action genre, a documentary genre, a romantic genre, or an animation genre, but the disclosure is not limited to the described embodiment. For example, the electronic device 200 may obtain user's preferences respectively for the news genre, the action genre, the documentary genre, the romantic genre, and the animation genre which are included in the plurality of content genres.

According to an embodiment of the disclosure, the electronic device 200 may obtain the user's preferences 1214 and 1224 in an initial setting process (e.g., an onboarding process). For example, in the initial setting process (e.g., the onboarding process) of the electronic device 200, the electronic device 200 may obtain at least one of the user's preference 1214 for the plurality of streaming services 1212 or the user's preference 1224 for the plurality of content genres 1222. For example, the electronic device 200 may obtain the user's preferences 1214 and 1224 in an onboarding process of a dedicated application for controlling the electronic device 200.

FIG. 13 is a reference diagram for describing a process in which the electronic device 200 obtains a priority order for a sub-content genre, according to an embodiment of the disclosure.

In an embodiment of the disclosure, each of the plurality of content genres 1222 described with reference to FIG. 12 may include a plurality of sub-content genres. For example, a news genre may include at least one sub-content genre among sports news, entertainment news, politics news, general news, or weather news, but the disclosure is not limited to the described embodiment. For example, an action genre may include at least one sub-content genre among a crime genre, a superhero genre, a science fiction (SF) genre, or a spy/espionage genre, but the disclosure is not limited to the described embodiment. For example, a documentary genre may include at least one sub-content genre among a nature documentary, a history documentary, a science documentary, a social issue documentary, or a music documentary, but the disclosure is not limited to the described embodiment. For example, a romantic genre may include at least one sub-content genre among a romantic comedy, a youth romance, or a melodrama romance, but the disclosure is not limited to the described embodiment. For example, an animation genre may include at least one sub-content genre among a family animation, a Japan-style animation, a comedy animation, or an adventure animation, but the disclosure is not limited to the described embodiment.

According to an embodiment of the disclosure, the electronic device 200 may obtain (or, collect) a usage history 1300 (e.g., viewing history) of a user. The electronic device 200 may obtain the usage history 1300 (e.g., viewing history) of the user for a defined period (e.g., 1 month or 1 week). For example, based on a streaming service or content being selected (or, played back), the electronic device 200 may obtain the usage history 1300 (e.g., viewing history) of the user. The electronic device 200 may identify a sub-genre of user-played content, based on the usage history 1300 (e.g., viewing history). The electronic device 200 may determine priority orders for a plurality of sub-content genres by aggregating (e.g., counting) genres of selected (e.g., played) content.

According to an embodiment of the disclosure, the electronic device 200 may obtain a priority order corresponding to a sub-content genre, based on the usage history 1300. For example, based on the usage history, the electronic device 200 may obtain focus priority orders corresponding to a plurality of sub-content genres included in the plurality of content genres 1222 obtained with reference to FIG. 12. For example, focus priority orders may include priority orders of a focus or priority orders of setting a focus. The electronic device 200 may obtain priority orders corresponding to the plurality of sub-content genres included in each of the plurality of content genres 1222, based on the usage history 1300 (e.g., viewing history). The electronic device 200 may set a focus, based on the priority orders corresponding to the plurality of sub-content genres.

In an embodiment of the disclosure, the electronic device 200 may obtain focus priority orders corresponding to a plurality of sub-content genres, based on a preference and usage history of a user. For example, the electronic device 200 may first obtain a focus priority order for a content genre based on a user's preference. The electronic device 200 may determine a focus priority order for a sub-content genre based on a usage history, and thus, may determine content on which a focus is to be set from among a plurality of pieces of content included in the same content genre. For example, the electronic device 200 may first obtain a focus priority order for a content genre based on a user's preference. The electronic device 200 may apply a high focus priority order to a most selected (or played) sub-content genre from among sub-content genres, based on a usage history.

For example, when a focus priority order for a news genre obtained based on a user's preference is a 1^{st} rank, and a plurality of pieces of news content are output on a display screen of the electronic device 200, a focus may be determined based on a usage history of sub-content genres of the news genre. For example, when sports news has been most frequently viewed from among sports news, entertainment news, politics news, general news, or weather news during a period defined by the electronic device 200, the electronic device 200 may set the focus on the sports news.

However, there may be a case in which it is not possible to set the focus based on a user's preference and a user's usage history. For example, in a case where a focus priority order for a news genre obtained based on a user's preference is a 1^{st} rank, and sports news has been most frequently viewed from among sports news, entertainment news, politics news, general news, or weather news during a period defined by the electronic device 200, but when a plurality of items of sports news are output on the display screen of the electronic device 200, the electronic device 200 is not able to determine the focus. This case will now be described with reference to FIG. 14.

FIG. 14 is a reference diagram for describing an operation of the electronic device 200 in a case where priority orders of a focus are the same for a plurality of items in operation 1170, according to an embodiment of the disclosure.

In an embodiment of the disclosure, the electronic device 200 is not able to determine a focus, based on a preference and usage history of a user. The electronic device 200 may identify that priority orders of a focus with respect to a plurality of pieces of content which are determined based on a preference and usage history of a user are equal. The electronic device 200 may identify that there are a plurality of pieces of content that correspond to a highest priority order of the focus from among priority orders of the focus which are determined based on the preference and usage history of the user. The electronic device 200 may transmit, to the wearable device 100, an indication that there are a plurality of pieces of content that correspond to a highest priority order of the focus from among priority orders of the focus which are determined based on the preference and usage history of the user.

For example, based on a user's preference for a plurality of streaming services and preference for a plurality of genres, the electronic device 200 may identify that a preference for a first streaming service from among the plurality of streaming services is the highest one, and a preference for a news genre from among the plurality of genres is the highest one. For example, the electronic device 200 may identify that a focus preference order for a sports news genre from among sub-content genres of the news genre is the highest one, based on a user's usage history for a defined time period.

The electronic device 200 may identify that there are a plurality of pieces of content that correspond to a highest focus preference order from among a plurality of pieces of content output on a user interface 1410. For example, the electronic device 200 may identify that content that correspond to a highest focus preference order from among the plurality of pieces of content output on a user interface 1410 includes first sports news and second sports news.

In an embodiment of the disclosure, when a plurality of pieces of content correspond to a highest focus preference order from among the plurality of pieces of content output on the user interface 1410, the electronic device 200 may identify an initial focus position 1412. In an embodiment of the disclosure, the electronic device 200 may obtain a direction in which the wearable device 100 is moved. The electronic device 200 may determine, from the initial focus position 1412, a focus 1414 based on the obtained direction in which the wearable device 100 is moved.

In an embodiment of the disclosure, the wearable device 100 may identify the direction in which the wearable device 100 is moved. For example, based on the direction in which the wearable device 100 is moved, the wearable device 100 may determine to change a focus of the electronic device 200. For example, based on the direction in which the wearable device 100 is moved, the wearable device 100 may determine a direction in which the focus of the electronic device 200 is to be changed. For example, the wearable device 100 may transmit the direction in which the focus is to be changed, to the electronic device 200. For example, based on the direction in which the wearable device 100 is moved, the wearable device 100 may transmit, to the electronic device 200, a command for requesting to change the focus of the electronic device 200.

For example, when the wearable device 100 is moved in a right direction 1416, the electronic device 200 may set the focus 1414 on content 1402 that is first shown to the right of the initial focus position 1412. For example, when the wearable device 100 is moved in the right direction 1416, the wearable device 100 may request the electronic device 200 to set the focus 1414 on the content 1402 that is first shown to the right of the initial focus position 1412.

For example, when the wearable device 100 is moved in a downward direction 1426, the electronic device 200 may set the focus 1416 on content 1404 that is first shown to the bottom of the initial focus position 1412. For example, when the wearable device 100 is moved in the downward direction 1426, the wearable device 100 may request the electronic device 200 to set the focus 1416 on the content 1404 that is first shown to the bottom of the initial focus position 1412.

The electronic device 200 may determine the focus based on at least one of a preference, a usage history, or a direction in which the wearable device 100 is moved, so that the inconvenience of requiring the user to slightly move the wearable device 100 to determine the focus may be reduced, and the user may experience a more intuitive and efficient interface. By doing so, the electronic device 200 may increase user convenience by determining the focus according to a personal characteristic of the user while lessening inconvenience of the user.

FIG. 15 is a reference diagram for describing an operation according to rotation of an edge part of a display of the wearable device 100, according to an embodiment of the disclosure.

Referring to FIG. 15, the wearable device 100 may include edge parts 1510 and 1520 of the display. The edge parts 1510 and 1520 of the display of the wearable device 100 may serve to separate the display from other elements. The edge parts 1510 and 1520 of the display may indicate a portion of the display or may indicate separate elements that surround a screen of the display. The edge parts 1510 and 1520 of the display may indicate a bezel (e.g., a touch bezel or a rotating bezel), the disclosure is not limited the disclosed embodiment and may be applied in various forms. In an embodiment of the disclosure, the touch bezel may indicate a display edge part in which a touch sensor is embedded. The rotating bezel may indicate a display edge part that is physically rotational.

In an embodiment of the disclosure, based on rotation of the edge parts 1510 and 1520 of the display, the wearable device 100 may control a screen to be vertically scrolled, the screen being output on a display of the electronic device 200. By doing so, the user may scroll a screen of the electronic device 200 without looking the wearable device 100, so that more convenient no-look manipulation is available.

In an embodiment of the disclosure, the wearable device 100 may recognize rotation of the edge parts 1510 and 1520 of the display. The wearable device 100 may recognize rotation direction and an amount of rotation of the edge parts 1510 and 1520 of the display. For example, the wearable device 100 may recognize rotation of the edge parts 1510 and 1520 of the display by using a sensor included in the edge parts 1510 and 1520 of the display.

In an embodiment of the disclosure, based on rotation of the edge parts 1510 and 1520 of the display being recognized, the wearable device 100 may transmit, to the electronic device 200, a command for requesting to perform an operation of the electronic device 200 corresponding to the rotation of the edge parts 1510 and 1520 of the display. For example, the wearable device 100 may transmit, to the electronic device 200 via the communication interface 110, a command for requesting to vertically scroll a screen output on the display of the electronic device 200.

In an embodiment of the disclosure, according to the edge parts 1510 and 1520 of the display included in the wearable device 100 being rotating in a first direction, the wearable device 100 may transmit, to the electronic device 200, a command for requesting to upwardly scroll a screen 1530 output on the display of the electronic device 200. In an embodiment of the disclosure, according to the edge parts 1510 and 1520 of the display included in the wearable device 100 being rotating in a second direction, the wearable device 100 may transmit, to the electronic device 200, a command for requesting to downwardly scroll the screen 1530 output on the display of the electronic device 200. In an embodiment of the disclosure, the first direction or the second direction may include at least one of a clockwise direction or a counterclockwise direction.

According to an embodiment of the disclosure, based on a recognized rotation direction and a recognized amount of rotation of the edge parts 1510 and 1520 of the display, the wearable device 100 may transmit, to the electronic device 200, a command for requesting to vertically scroll the screen 1530 output on the display of the electronic device 200. For example, the wearable device 100 may include a defined proportional relation with respect to an amount of rotation of the edge parts 1510 and 1520 of the display and a level of vertical scrolling of a screen output on the display of the electronic device 200. Based on an amount of rotation of the edge parts 1510 and 1520 of the display, the wearable device 100 may determine a level of vertical scrolling of the screen output on the display of the electronic device 200. For example, the wearable device 100 may transmit a command to the electronic device 200 so that the screen output on the display of the electronic device 200 may be further vertically scrolled when the edge parts 1510 and 1520 of the display further rotate.

In an embodiment of the disclosure, the electronic device 200 may scroll the screen 1530 output on the display, in at least one of an upward direction or a downward direction, based on a command received from the wearable device 100.

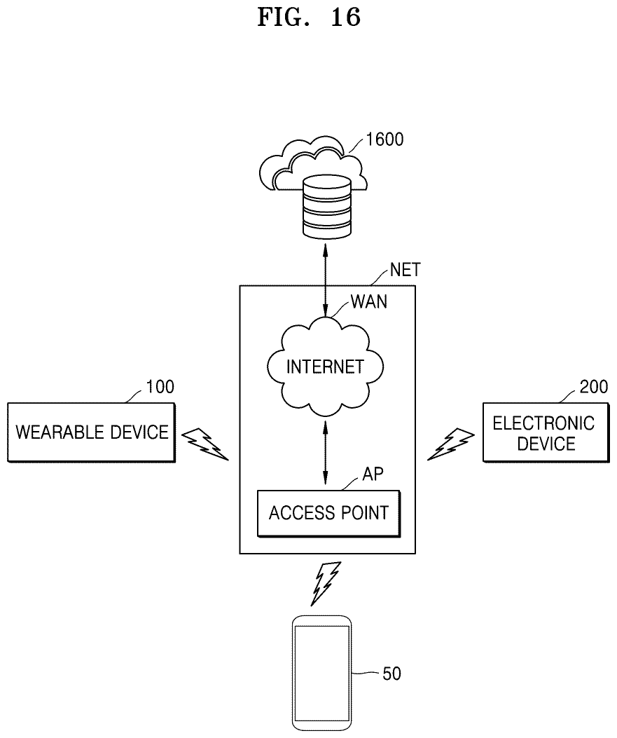

FIG. 16 is a diagram illustrating the wearable device 100, the electronic device 200, a user terminal 50, and a server 1600, according to an embodiment of the disclosure.

According to an embodiment of the disclosure, the wearable device 100 may communicate with at least one of the electronic device 200, the user terminal 50, or a home appliance via the communication interface 110. The wearable device 100 may be connected to at least one of the electronic device 200, the user terminal 50, a home appliance, or the server 1600 via a network NET.

The server 1600 may manage user account information and information of the wearable device 100 connected to a user account. For example, a user may access the server 1600 via the wearable device 100, the user terminal 50, and/or the electronic device 200, thereby generating a user account. The user account may be identified by an identification and a password which are set by the user. The server 1600 may register the wearable device 100, the user terminal 50, and/or the electronic device 200 to the user account, according to a defined procedure. For example, the server 1600 may connect identification information (e.g., serial number or medium access control (MAC) address) of the wearable device 100, the user terminal 50, and/or the electronic device 200 to the user account, thereby registering the wearable device 100, the user terminal 50, and/or the electronic device 200 to the user account.

The user terminal 50 may include a communication interface capable of communicating with the wearable device 100, the electronic device 200, and the server 1600, a user interface configure to receive a user input or outputting information to a user, at least one processor configured to control an operation of the user terminal 50, and at least one memory storing a program for controlling an operation of the user terminal 50.

The user terminal 50 may be carried by a user or may be arranged at home or an office of the user The user terminal 50 may include a personal computer, a terminal device, a portable telephone, a smart phone, a handheld device, a wearable device, etc., but the disclosure is not limited thereto.

The network NET may include both a wired network and a wireless network. The wired network may include a cable network or a telephone network, and the wireless network may include all networks that transmit and receive signals over radio waves. The wired network and the wireless network may be connected to each other.

The network NET may include a local area network (LAN) established around a wide area network (WAN) such as Internet, and an access point (AP), and a wireless personal area network (WPAN) without accessing the AP. The WPAN may include Bluetooth™ (IEEE 802.15.1), ZigBee (IEEE 802.15.4), Wi-Fi Direct, NFC, Z-Wave, etc. but the present disclosure is not limited thereto.

The AP may connect a LAN to which the wearable device 100, the electronic device 200, and the user terminal 50 are connected to a WAN to which the server 1600 is connected. The wearable device 100, the electronic device 200, and the user terminal 50 may be connected to the server 1600 via the WAN.

The AP may include a device that enables devices to be connected in a computer network by using relevant standards for Wi-Fi. According to embodiments of the disclosure, the AP may include an AP implemented in hardware and an AP implemented in software. For example, the AP may relay data between a wireless device and a wired device on a network. However, the disclosure is not limited thereto, and the AP may relay data between wired devices or data between wireless devices. The AP may also be referred to as a relay device.

The AP may communicate with the wearable device 100, the electronic device 200, and the user terminal 50 by using wireless communication such as Wi-Fi™ of IEEE 802.11, etc., and may access the WAN by using wired communication.

The electronic device 200 may transmit information about an operation or a state to the server 1600 via the network NET. For example, the electronic device 200 may transmit information about an operation or a state to the server 1600 via Wi-Fi communication (Wi-Fi™ of IEEE 802.11).

The electronic device 200 may provide information about an operation or a state of the electronic device 200 to the server 1600, according to a prior approval of a user. Information transmission to the server 1600 may be performed when a request of the server 1600 is received, may be performed when a particular event occurs in the electronic device 200, or may be performed periodically or in real time.

The wearable device 100 and/or the electronic device 200 may obtain various information from the server 1600, and may provide the obtained information to a user. Also, the wearable device 100 and/or the electronic device 200 may receive, from the server 1600, a file for updating pre-installed software or data related to the pre-installed software, and may update the pre-installed software or the data related to the pre-installed software, based on the received file.

The electronic device 200 may operate according to a control command received from the server 1600. For example, when the electronic device 200 obtains a user's prior approval by which the electronic device 200 is able to operate according to a control command from the server 1600 even without a user input, the electronic device 200 may operate according to the control command received from the server 1600. The control command received from the server 1600 may include a control command that the user has input via the wearable device 100 and/or the user terminal 50 or a control command that is generated by the server 1600 based on a preset condition, but the disclosure is not limited thereto.

According to an aspect of the disclosure, an operating method of a wearable device includes activating a remote control of an electronic device based on a trigger gesture being identified by using at least one sensor included in the wearable device that detects a first motion of the wearable device; determining, in response to a second motion of the wearable device and a direction in which the wearable device faces, an operation to be performed by the electronic device; and based on identifying the second motion of the wearable device, transmitting, to the electronic device, a command that causes the electronic device to perform the operation of the electronic device, the operation corresponding to the second motion of the wearable device.

The determining of the operation to be performed by the electronic device according to the second motion of the wearable device and the direction in which the wearable device faces, further includes: identifying the direction in which the wearable device faces; determining the operation to be performed by the electronic device according to a direction in which the wearable device is moved and the direction in which the wearable device faces; and determining, based on the direction in which the wearable device faces, a type of gesture mapping to which a function of the electronic device is mapped, the function corresponding to a gesture of a user wearing the wearable device.

The determining of the operation to be performed by the electronic device according to the direction in which the wearable device is moved and the direction in which the wearable device faces, further includes: performing, according to the direction in which the wearable device is moved, a first determination to request a change of a position of a pointer output on a display of the electronic device or to request a change of a focus output on the display of the electronic device.

The transmitting, to the electronic device, the command that causes the electronic device to perform the operation of the electronic device based on the second motion of the wearable device being identified, further includes: identifying a direction of the second motion of the wearable device based on first sensing data obtained by using the at least one sensor; and according to the first determination, transmitting, to the electronic device, the command that causes the electronic device to change the position of the pointer or the focus based on the direction of the second motion of the wearable device.

The determined type of the gesture mapping is one of a basic gesture mapping and playback control gesture mapping, the basic gesture mapping includes a corresponding relation between a plurality of gestures of the user wearing the wearable device and a command for requesting to perform at least one function of the electronic device, from among an item selection function, an item cancellation function, a return-to-home screen function, or a playback/pause function, and the playback control gesture mapping includes a corresponding relation between the plurality of gestures of the user wearing the wearable device and a command for requesting a change of at least one of a channel of the electronic device or a volume of the electronic device.

Based on the second motion of the wearable device being identified, the transmitting, to the electronic device, the command that causes the electronic device to perform the operation of the electronic device, further includes: identifying the gesture of the user wearing the wearable device, by inputting second sensing data to an artificial intelligence model, the second sensing data obtained by using the at least one sensor; and transmitting, to the electronic device, the command that causes the electronic device to perform the operation of the electronic device, the operation corresponding to the gesture and the determined type of the gesture mapping.

The identifying of the gesture of the user wearing the wearable device, by inputting the second sensing data to the artificial intelligence model, further includes identifying the gesture of the user wearing the wearable device, from among a pinch gesture, a double pinch gesture, a fist gesture, a double fist gesture, or a back-and-forth gesture, by inputting acceleration sensing data obtained by using an acceleration sensor to the artificial intelligence model, in which the artificial intelligence model is trained to identify the gesture of the user wearing the wearable device based on the acceleration sensing data obtained by using the acceleration sensor.

The method further includes determining a request to change a focus output on a display of the electronic device according to the second motion of the wearable device based on the direction in which the wearable device faces; receiving an indication that there are two or more pieces of content that correspond to a highest focus priority order from among focus priority orders for a plurality of pieces of content output on the display of the electronic device, the focus priority orders being determined in the electronic device based on at least one of a preference of the user or a usage history of the user; identifying the direction in which the wearable device is moved; determining a direction in which the focus is to be changed based on the direction the wearable device is moved; and transmitting, to the electronic device, the direction in which the focus is to be changed.

The operating method further includes requesting the electronic device to scroll a screen output on a display of the electronic device based on rotation of an edge part of a display of the wearable device.

The operating method further includes: outputting, to a display of the wearable device, a user interface corresponding to the determined type of gesture mapping.

The identifying of the direction in which the wearable device faces includes at least one of: identifying a direction in which a front face of a display of the wearable device faces; identifying a direction in which a back of a hand of the user wearing the wearable device faces; or identifying an angle between the back of the hand of the user and ground.

The operating method of claim 1, further includes: deactivating the remote control of the electronic device according to a third motion of the wearable device based on the third motion of the wearable device not being identified for a defined time period.

According to an aspect of the disclosure, a wearable device includes: a communication interface; memory including at least one instruction; at least one processor including processing circuitry operatively coupled to the memory; a display; and a plurality of sensors including an acceleration sensor and a gyroscope sensor, in which the at least one instruction, when executed by the at least one processor, causes the wearable device to: activate a remote control of an electronic device based on a trigger gesture being identified by using at least one sensor included in the wearable device that detects a first motion of the wearable device, determine, in response to a second motion of the wearable device and a direction in which the wearable device faces, an operation to be performed by the electronic device, and based on identifying the second motion of the wearable device, transmit, to the electronic device, a command that causes the electronic device to perform the operation of the electronic device, the operation corresponding to the second motion of the wearable device.

The at least one instruction, when executed by the at least one processor, causes the wearable device to: identify the direction in which the wearable device faces, determine the operation to be performed by the electronic device according to a direction in which the wearable device is moved and the direction in which the wearable device faces, and determine, based on the direction in which the wearable device faces, a type of gesture mapping to which a function of the electronic device is mapped, the function corresponding to a gesture of a user wearing the wearable device. The at least one instruction, when executed by the at least one processor, causes the wearable device to: perform, according to the direction in which the wearable device is moved, a first determination to request a change of a position of a pointer output on a display of the electronic device or to request a change of a focus output on the display of the electronic device.

The at least one instruction, when executed by the at least one processor, causes the wearable device to: identify a direction of the second motion of the wearable device based on first sensing data obtained by using the at least one sensor, and according to the first determination, transmit, to the electronic device, the command that causes the electronic device to change the position of the pointer or the focus based on the direction of the second motion of the wearable device.

The determined type of the gesture mapping is one of basic gesture mapping and playback control gesture mapping, the basic gesture mapping includes a corresponding relation between a plurality of gestures of the user wearing the wearable device and a command for requesting to perform at least one function of the electronic device, from among an item selection function, an item cancellation function, a return-to-home screen function, or a playback/pause function, and the playback control gesture mapping includes a corresponding relation between the plurality of gestures of the user wearing the wearable device and a command for requesting a change of at least one of a channel of the electronic device or a volume of the electronic device.

The at least one instruction, when executed by the at least one processor, causes the wearable device to: identify the gesture of the user wearing the wearable device, by inputting second sensing data to an artificial intelligence model, the second sensing data obtained by using the at least one sensor, and transmit, to the electronic device, the command that causes the electronic device to perform the operation of the electronic device, the operation corresponding to the gesture and the determined type of the gesture mapping.

The at least one instruction, when executed by the at least one processor, causes the wearable device to identify the gesture of the user wearing the wearable device, from among a pinch gesture, a double pinch gesture, a fist gesture, a double fist gesture, or a back-and-forth gesture, by inputting acceleration sensing data obtained by using the acceleration sensor to the artificial intelligence model, and the artificial intelligence model is trained to identify the gesture of the user wearing the wearable device based on the acceleration sensing data obtained by using the acceleration sensor.

According to an aspect of the disclosure, an electronic device includes: a communication interface; a memory including at least one instruction; at least one processor including processing circuitry operatively coupled to the memory; and a display, in which the at least one instruction, when executed by the at least one processor, causes the electronic device to: obtain a preference of a user for at least one of a plurality of content genres or a plurality of streaming services, obtain a usage history of the user of the electronic device for a defined period, obtain one or more focus priority orders for a plurality of pieces of content output on the display of the electronic device based on at least one of the preference or the usage history, and based on determining there are two or more pieces of content that correspond to a highest focus priority order, determine a focus of the electronic device, based on a direction in which a wearable device is moved.

According to an embodiment of the disclosure, a computer-readable recoding medium having recorded thereon a program for executing any one method described above, on a computer, may be provided.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to an embodiment of the disclosure, the method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user apparatuses (e.g., smartphones). In a case of online distribution, at least a portion of the computer program product (e.g., a downloadable application) may be at least temporarily stored or temporarily generated in a machine-readable storage medium such as a manufacturer's server, a server of an application store, or a memory of a relay server.

In an embodiment of the disclosure, a third device may execute the computer program product to control a device communicatively connected to the third device to perform the method according to an embodiment disclosed herein. When the third device executes the computer program product, the third device may download the computer program product from a server, and may execute the downloaded computer program product. Alternatively, the third device may execute the computer program product provided in a pre-loaded state to perform the method according to the embodiments disclosed herein.

Also, throughout the specification, the term “interface” may indicate a hardware component such as a processor or circuitry, and/or may indicate a software component that is executed by a hardware configuration such as a processor.

While the disclosure has been particularly shown and described with reference to the accompanying drawings, in which embodiments of the disclosure are shown, it is obvious to one of ordinary skill in the art that the disclosure may be easily embodied in many different forms without changing the technical concept or essential features of the disclosure. Thus, it should be understood that the embodiments described herein should be considered in a descriptive sense only and not for purposes of limitation. For example, configuring elements that are singular forms may be executed in a distributed fashion, and also, configuring elements that are distributed may be combined and then executed.

The scope of the disclosure is defined by the appended claims, rather than defined by the aforementioned detailed descriptions, and all differences and modifications that can be derived from the meanings and scope of the claims and other equivalent embodiments therefrom will be construed as being included in the disclosure.

What is claimed is

1. An operating method of a wearable device, the operating method comprising:
activating a remote control of an electronic device based on a trigger gesture being identified by using at least one sensor comprised in the wearable device that detects a first motion of the wearable device;
determining, in response to a second motion of the wearable device and a direction in which the wearable device faces, an operation to be performed by the electronic device; and
based on identifying the second motion of the wearable device, transmitting, to the electronic device, a command that causes the electronic device to perform the operation of the electronic device, the operation corresponding to the second motion of the wearable device.

2. The operating method of claim 1, wherein the determining, in response to a second motion of the wearable device and a direction in which the wearable device faces, an operation to be performed by the electronic device, further comprises:
identifying the direction in which the wearable device faces;
based on the direction in which the wearable device faces, determining the operation to be performed by the electronic device corresponding to a direction in which the wearable device is moved, ; and
determining, based on the direction in which the wearable device faces, a type of gesture mapping to which a function of the electronic device is mapped, the function corresponding to a gesture of a user wearing the wearable device.

3. The operating method of claim 2, wherein the determining of the operation to be performed by the electronic device according to the direction in which the wearable device is moved and the direction in which the wearable device faces, further comprises:
performing, according to the direction in which the wearable device is moved, a first determination to request a change of a position of a pointer output on a display of the electronic device or to request a change of a focus output on the display of the electronic device.

4. The operating method of claim 3, wherein the transmitting, to the electronic device, the command that causes the electronic device to perform the operation of the electronic device based on the second motion of the wearable device being identified, further comprises:
identifying a direction of the second motion of the wearable device based on first sensing data obtained by using the at least one sensor; and
according to the first determination, transmitting, to the electronic device, the command that causes the electronic device to change the position of the pointer or the focus based on the direction of the second motion of the wearable device.

5. The operating method of claim 2, wherein
the determined type of the gesture mapping is one of a basic gesture mapping and playback control gesture mapping,
the basic gesture mapping comprises a corresponding relation between a plurality of gestures of the user wearing the wearable device and a command for requesting to perform at least one function of the electronic device, from among an item selection function, an item cancellation function, a return-to-home screen function, or a playback/pause function, and
the playback control gesture mapping comprises a corresponding relation between the plurality of gestures of the user wearing the wearable device and a command for requesting a change of at least one of a channel of the electronic device or a volume of the electronic device.

6. The operating method of claim 2, wherein, based on the second motion of the wearable device being identified, the transmitting, to the electronic device, the command that causes the electronic device to perform the operation of the electronic device, further comprises:
identifying the gesture of the user wearing the wearable device, by inputting second sensing data to an artificial intelligence model, the second sensing data obtained by using the at least one sensor; and
transmitting, to the electronic device, the command that causes the electronic device to perform the operation of the electronic device based on the determined type of the gesture mapping, wherein the operation corresponds to the gesture,.

7. The operating method of claim 6,
wherein the identifying of the gesture of the user wearing the wearable device, by inputting the second sensing data to the artificial intelligence model, further comprises identifying the gesture of the user wearing the wearable device, from among a pinch gesture, a double pinch gesture, a fist gesture, a double fist gesture, or a back-and-forth gesture, by inputting acceleration sensing data obtained by using an acceleration sensor to the artificial intelligence model,
wherein the artificial intelligence model is trained to identify the gesture of the user wearing the wearable device based on the acceleration sensing data obtained by using the acceleration sensor.

8. The operating method of claim 2, further comprising:
determining a request to change a focus output on a display of the electronic device according to the second motion of the wearable device based on the direction in which the wearable device faces;
receiving an indication that there are two or more pieces of content that correspond to a highest focus priority order from among focus priority orders for a plurality of pieces of content output on the display of the electronic device, the focus priority orders being determined in the electronic device based on at least one of a preference of the user or a usage history of the user;
identifying the direction in which the wearable device is moved;
determining a direction in which the focus is to be changed based on the direction the wearable device is moved; and
transmitting, to the electronic device, the direction in which the focus is to be changed.

9. The operating method of claim 1, further comprising:
requesting the electronic device to scroll a screen output on a display of the electronic device based on rotation of an edge part of a display of the wearable device.

10. The operating method of claim 1, further comprising:
outputting, to a display of the wearable device, a user interface corresponding to the determined type of gesture mapping.

11. The operating method of claim 2, wherein the identifying of the direction in which the wearable device faces comprises at least one of:
identifying a direction in which a front face of a display of the wearable device faces;
identifying a direction in which a back of a hand of the user wearing the wearable device faces; or
identifying an angle between the back of the hand of the user and ground.

12. The operating method of claim 1, further comprising:
deactivating the remote control of the electronic device according to a third motion of the wearable device based on the third motion of the wearable device not being identified for a defined time period.

13. A wearable device comprising:
a communication interface;
memory comprising at least one instruction;
at least one processor comprising processing circuitry operatively coupled to the memory;
a display; and
a plurality of sensors comprising an acceleration sensor and a gyroscope sensor,
wherein the at least one instruction, when executed by the at least one processor, causes the wearable device to:
activate a remote control of an electronic device based on a trigger gesture being identified by using at least one sensor comprised in the wearable device that detects a first motion of the wearable device,
determine, in response to a second motion of the wearable device and a direction in which the wearable device faces, an operation to be performed by the electronic device, and
based on identifying the second motion of the wearable device, transmit, to the electronic device, a command that causes the electronic device to perform the operation of the electronic device, the operation corresponding to the second motion of the wearable device.

14. The wearable device of claim 13, wherein the at least one instruction, when executed by the at least one processor, causes the wearable device to:
identify the direction in which the wearable device faces,
based on the direction in which the wearable device faces, determine the operation to be performed by the electronic device corresponding to a direction in which the wearable device is moved, and
determine, based on the direction in which the wearable device faces, a type of gesture mapping to which a function of the electronic device is mapped, the function corresponding to a gesture of a user wearing the wearable device.

15. The wearable device of claim 14, wherein the at least one instruction, when executed by the at least one processor, causes the wearable device to:
perform, according to the direction in which the wearable device is moved, a first determination to request a change of a position of a pointer output on a display of the electronic device or to request a change of a focus output on the display of the electronic device.

16. The wearable device of claim 15, wherein the at least one instruction, when executed by the at least one processor, causes the wearable device to:
identify a direction of the second motion of the wearable device based on first sensing data obtained by using the at least one sensor, and
according to the first determination, transmit, to the electronic device, the command that causes the electronic device to change the position of the pointer or the focus based on the direction of the second motion of the wearable device.

17. The wearable device of claim 14, wherein
the determined type of the gesture mapping is one of basic gesture mapping and playback control gesture mapping,
the basic gesture mapping comprises a corresponding relation between a plurality of gestures of the user wearing the wearable device and a command for requesting to perform at least one function of the electronic device, from among an item selection function, an item cancellation function, a return-to-home screen function, or a playback/pause function, and
the playback control gesture mapping comprises a corresponding relation between the plurality of gestures of the user wearing the wearable device and a command for requesting a change of at least one of a channel of the electronic device or a volume of the electronic device.

18. The wearable device of claim 14, wherein the at least one instruction, when executed by the at least one processor, causes the wearable device to:
identify the gesture of the user wearing the wearable device, by inputting second sensing data to an artificial intelligence model, the second sensing data obtained by using the at least one sensor, and
transmit, to the electronic device, the command that causes the electronic device to perform the operation of the electronic device based on the determined type of the gesture mapping, wherein the operation corresponds to the gesture.

19. The wearable device of claim 18, wherein
the at least one instruction, when executed by the at least one processor, causes the wearable device to identify the gesture of the user wearing the wearable device, from among a pinch gesture, a double pinch gesture, a fist gesture, a double fist gesture, or a back-and-forth gesture, by inputting acceleration sensing data obtained by using the acceleration sensor to the artificial intelligence model, and
the artificial intelligence model is trained to identify the gesture of the user wearing the wearable device based on the acceleration sensing data obtained by using the acceleration sensor.

20. An electronic device comprising:
a communication interface;
a memory comprising at least one instruction;
at least one processor comprising processing circuitry operatively coupled to the memory; and
a display,
wherein the at least one instruction, when executed by the at least one processor, causes the electronic device to:
obtain a preference of a user for at least one of a plurality of content genres or a plurality of streaming services,
obtain a usage history of the user of the electronic device for a defined period,
obtain one or more focus priority orders for a plurality of pieces of content output on the display of the electronic device based on at least one of the preference or the usage history, and
based on determining there are two or more pieces of content that correspond to a highest focus priority order, determine a focus of the electronic device, based on a direction in which a wearable device is moved.
